(19) United States
(12) Patent Application Publication
(10) Pub. No.: US 2026/0089582 A1
(43) Pub. Date: Mar. 26, 2026

(54) SLICE AWARE MOBILITY

(71) Applicant: QUALCOMM Incorporated, San Diego, CA (US)

(72) Inventors: Jianhua LIU, Beijing (CN); Peng CHENG, Beijing (CN); Ozcan OZTURK, San Diego, CA (US); Miguel GRIOT, La Jolla, CA (US); Xipeng ZHU, San Diego, CA (US); Luis Fernando Brisson LOPES, Swindon (GB)

(21) Appl. No.: 19/108,928

(22) PCT Filed: Oct. 21, 2022
(86) PCT No.: PCT/CN2022/126615

§ 371 Date: Mar. 5, 2025

(51) Int. Cl. H04W 36/00; H04W 36/08

(52) U.S. Cl. CPC H04W 36/0058; H04W 36/08

(57) ABSTRACT

Aspects of the disclosure relate to techniques for slice aware mobility by facilitating slice specific user equipment (UE) measurement procedures and slice specific handover procedures for ongoing network slices of the UE. A network entity may configure a measurement report for the UE including one or more slice specific parameters. The UE may use the slice specific parameters to generate a measurement report including signal quality measurements of a serving cell and/or neighbor cells. The network entity may further identify candidate target cells for a handover based on the ongoing network slices of the UE and slice supporting capability information indicating neighbor cell(s) that support the ongoing network slices.

### TECHNICAL FIELD

The technology discussed below relates generally to wireless communication systems, and more particularly, to network slicing enhancements.

### INTRODUCTION

A network slice may be viewed as a logical network with specific functions/elements dedicated for a particular use case, service type, traffic type, or other business arrangements with agreed-upon Service-level Agreements (SLAs). Network slice types may include, but are not limited to, enhanced Mobile Broadband (eMBB), Ultra-Reliable Low Latency Communications (URLLC), massive Machine Type Communications (mMTC), and massive IoT (mIoT). A network slice may include both access and core network parts of a wireless communication system, such as a New Radio (NR) fifth generation (5G) system (5GS).

The 5GS may handle traffic for different network slices through different protocol data unit (PDU) sessions. Thus, each PDU session may be associated with a respective slice identifier (ID) represented by a single-network slice selection assistance information (S-NSSAI). Network slices are negotiated by a non-access stratum (NAS) registration procedure. For example, a user equipment (UE) may initiate a NAS registration request to an access and mobility management function (AMF) in a core network. The registration request may include a requested NSSAI including the S-NSSAI(s) corresponding to the slice(s) to which the UE would like to register. The AMF may respond with a NAS registration accept including a list of allowed S-NSSAIs and rejected S-NSSAIs. The UE may then establish a PDU session associated with an allowed NSSAI. In some examples, a single user equipment (UE) can simultaneously be served by up to eight network slices at any time.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a user equipment (UE) including a transceiver, a memory, and a processor coupled to the transceiver and the memory is disclosed. The processor is configured to receive, from a network entity and via the transceiver, a measurement report configuration including at least one slice specific parameter. Each slice specific parameter is associated with a respective set of one or more network slices of the UE. The processor is further configured to transmit a measurement report to the network entity based on the measurement report configuration via the transceiver. The measurement report includes at least one respective signal quality measurement of at least one of a serving cell or at least one neighbor cell.

Another example provides A network entity including a memory and a processor coupled to the memory. The processor is configured to receive slice information identifying at least one network slice configured for a user equipment (UE) and supported by a serving cell of the UE and receive slice supporting capability information indicating respective network slices supported by each of a plurality of neighbor cells of the serving cell. The processor is further configured to identify at least one candidate target cell of the plurality of neighbor cells for a handover of the at least one network slice based on the slice information and the slice supporting capability information. The at least one candidate target cell supports the at least one network slice.

Another example provides a user equipment (UE) including a transceiver, a memory, and a processor coupled to the transceiver and the memory. The processor is configured to receive a slice specific conditional handover configuration from a network entity via the transceiver. The slice specific conditional handover configuration is associated with at least one network slice of the UE. The processor is further configured to perform a conditional handover evaluation for the at least one network slice based on the slice specific conditional handover configuration.

Another example provides a network entity including a memory and a processor coupled to the memory. The processor is configured to provide a measurement report configuration for a user equipment (UE). The measurement report configuration including at least one slice specific parameter. Each slice specific parameter is associated with a respective set of one or more network slices of the UE. The processor is further configured to receive a measurement report based on the measurement report configuration. The measurement report including at least one respective signal quality measurement of at least one of a serving cell or at least one neighbor cell.

These and other aspects of the invention will become more fully understood upon a review of the detailed description, which follows. Other aspects, features, and examples will become apparent to those of ordinary skill in the art, upon reviewing the following description of specific, exemplary aspects in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary aspects may be discussed below as device, system, or method aspects, it should be understood that such exemplary aspects can be implemented in various devices, systems, and methods.

### BRIEF DESCRIPTION OF THE DRAWINGS

FIG. 1 is a schematic illustration of a wireless communication system according to some aspects.

FIG. 2 is a diagram illustrating an example of a radio access network (RAN) according to some aspects.

FIG. 3 is a schematic illustration of an organization of wireless resources in an air interface utilizing orthogonal frequency divisional multiplexing (OFDM) according to some aspects.

FIG. 4 is a diagram providing a high-level illustration of one example of a configuration of a disaggregated base station according to some aspects.

FIG. 5 is a block diagram illustrating an example of a 5G wireless communication system (5GS) according to some aspects.

FIGS. 6A-6D illustrate example slice aware mobility scenarios according to some aspects.

FIG. 7 is a signaling diagram illustrating exemplary signaling for slice specific measurement reporting according to some aspects.

FIG. 8 is a diagram illustrating exemplary events and associated parameters for triggering a measurement report according to some aspects.

FIG. 9 is a signaling diagram illustrating exemplary signaling for a slice specific conditional handover according to some aspects.

FIG. 10 is a signaling diagram illustrating exemplary signaling for a slice specific network-initiated handover according to some aspects.

FIG. 11 is a signaling diagram illustrating exemplary signaling to select one or more candidate cells for a handover based on slice specific information according to some aspects.

FIG. 12 is a block diagram conceptually illustrating an example of a hardware implementation for a user equipment according to some aspects.

FIG. 13 is a flow chart illustrating an exemplary method of facilitating slice aware mobility at a user equipment according to some aspects.

FIG. 14 is a flow chart illustrating another exemplary method of facilitating slice aware mobility at a user equipment according to some aspects.

FIG. 15 is a flow chart illustrating another exemplary method of facilitating slice aware mobility at a user equipment according to some aspects.

FIG. 16 is a block diagram conceptually illustrating an example of a hardware implementation for a network entity according to some aspects.

FIG. 17 is a flow chart illustrating an exemplary method of facilitating slice aware mobility at a network entity according to some aspects.

FIG. 18 is a flow chart illustrating another exemplary method of facilitating slice aware mobility at a network entity according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the disclosure relate to techniques for slice aware mobility. In current 5G deployments, UE measurement and handover procedures consider cell coverage and network load, but do not consider the different services or applications represented by network slices. When network slices are restricted based on various factors, including, but not limited to, frequency, location area, cell, time, or simultaneous usage of multiple (or specific combinations of) network slices, an ongoing slice service may be broken as a result of a handover to a cell or frequency that no longer supports the ongoing network slice. In addition, when different network slices are deployed in the same cell with different coverage in the cell, an ongoing network slice service may be broken as a result of the current handover procedures.

In various aspects, to enable slice aware mobility for UE measurement and handover, a network entity (e.g., an aggregated or disaggregated base station) may configure a slice specific measurement report configuration for a UE. The slice specific measurement report configuration may include one or more slice specific parameters. The UE may perform a measurement report evaluation using the slice specific report parameters for an ongoing network slice. In some examples, the measurement report configuration may be associated with an event-triggered measurement report. In this example, the network entity may configure one or more slice specific parameters for one or more events. In addition, the network entity may configure one or more common parameters for one or more events that may be applicable to all network slices or only network slices unsupported by neighboring cells. In some examples, a slice specific parameter may be configured as an offset to a common parameter.

In other examples, the measurement report configuration may be associated with a periodic measurement report. In this example, the network entity may configure a slice specific report interval for one or more network slices of the UE and/or may further configure a slice specific report amount for one or more of the network slices. Based on the slice specific parameter for an ongoing network slice, the UE may transmit a periodic measurement report each slice specific report interval and/or including the slice specific report number of signal quality measurements for the neighboring cells supporting the ongoing network slice. For neighbor cells that do not support the ongoing network slice, the network entity may further configure a common parameter (e.g., common report interval and/or common report number) for the UE to report measurement results of neighbor cells that do not support the ongoing network slice. In other examples, based on the slice specific parameter, the UE may transmit a periodic measurement report each slice specific report interval and/or including the slice specific report number of signal quality measurements for all cells irrespective of whether each cell supports the ongoing network slice.

In various aspects, the network entity may further configure a slice specific conditional handover configuration for a UE to facilitate slice aware mobility. The slice specific conditional handover configuration may include, for example, slice specific candidate target cells and/or slice specific execution conditions. The UE may apply the slice specific conditional handover configuration to the corresponding network slices. In examples in which the UE has multiple ongoing network slices, the UE may perform a conditional handover evaluation for each network slice and perform a conditional handover to a candidate target cell configured to a higher priority network slice. In other examples in which the UE has multiple ongoing network slices, the network entity may configure a respective slice specific conditional handover configuration for each ongoing network slice and indicate a priority or order of the slice specific conditional handover configurations. The UE may then perform conditional handover evaluations of network slices based on the priority or order and perform a conditional handover based on the priority or order.

In various aspects, the UE can send a measurement report including slice specific assistance information to the network entity for a network-initiated handover. The slice specific assistance information may include, for example, the measurement results of the neighbor cells supporting an ongoing network slice of the UE. In some examples, the measurement results may include the highest measurement indicating the best neighbor cell for the ongoing network slice. In other examples, the measurement report may indicate all available neighbor cells and include measurement results for the neighbor cells supporting the ongoing network slice. In examples in which the UE has multiple ongoing network slices, and the UE is configured with a priority for each network slice, the slice specific assistance information may further include the respective priority of each ongoing network slice.

In some examples, the network entity may select candidate target cells for a conditional handover and/or a target cell for a network-initiated handover based on the respective priority of the ongoing network slices of the UE. The network entity may receive priority information indicating the respective priority of each ongoing network slice from the UE, from a core network node (e.g., an AMF), or from a previously serving network entity of the UE. By enabling and supporting slice aware mobility, interruptions in ongoing network slice service may be prevented or minimized.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, radio frequency (RF) chains (RF-chains), power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

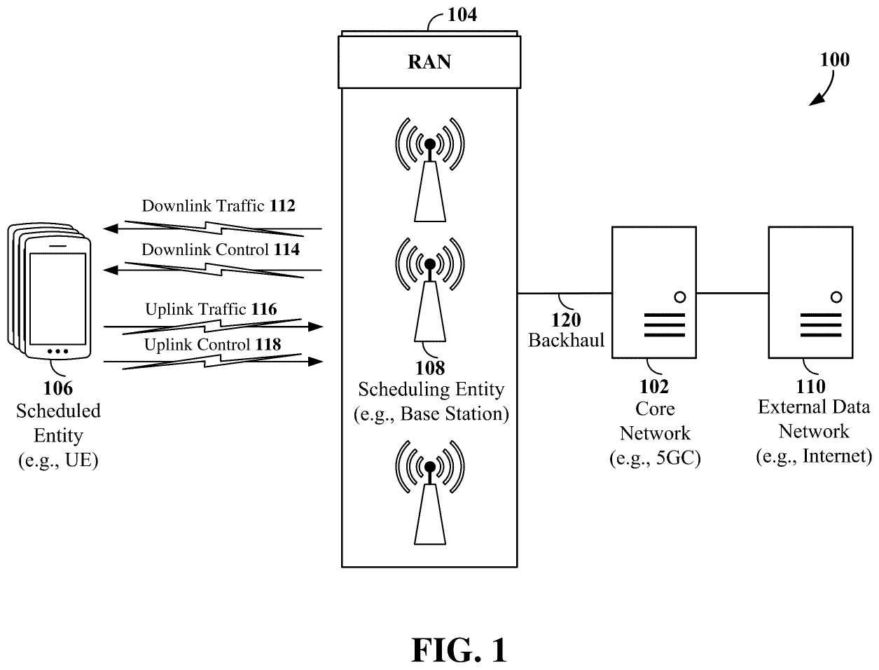

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station. In addition, one or more of the base stations may have a disaggregated configuration.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things”(IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmissions. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control information 114 and/or 118 and/or traffic 112 and/or 116 information may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

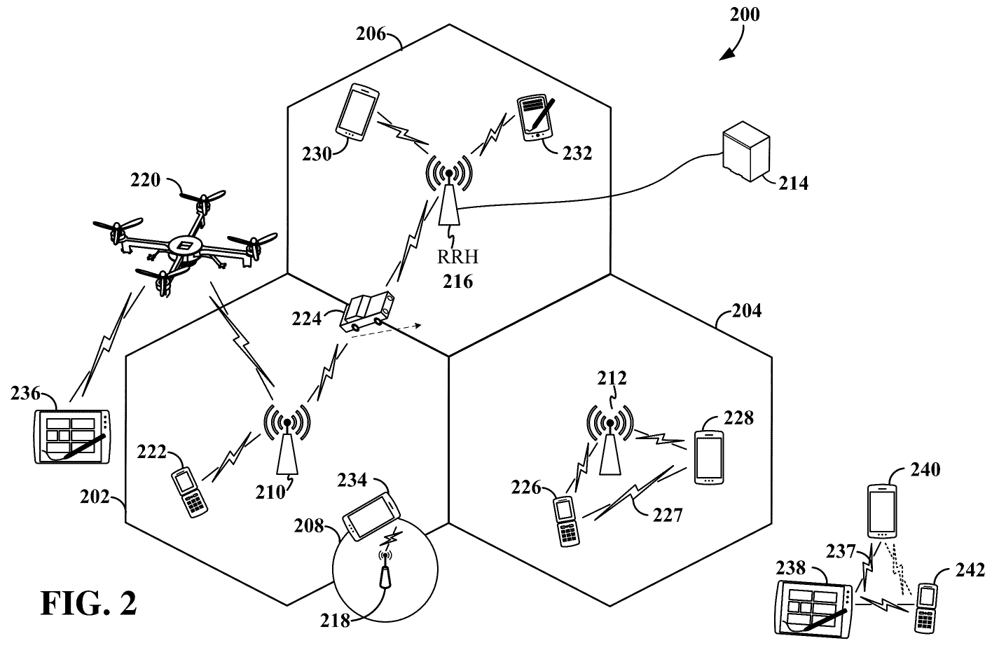

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In some examples, a D2D relay framework may be included within a cellular network to facilitate relaying of communication to/from the base station 212 via D2D links (e.g., sidelinks 227 or 237). For example, one or more UEs (e.g., UE 228) within the coverage area of the base station 212 may operate as relaying UEs to extend the coverage of the base station 212, improve the transmission reliability to one or more UEs (e.g., UE 226), and/or to allow the base station to recover from a failed UE link due to, for example, blockage or fading.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz 7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave”band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHZ), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

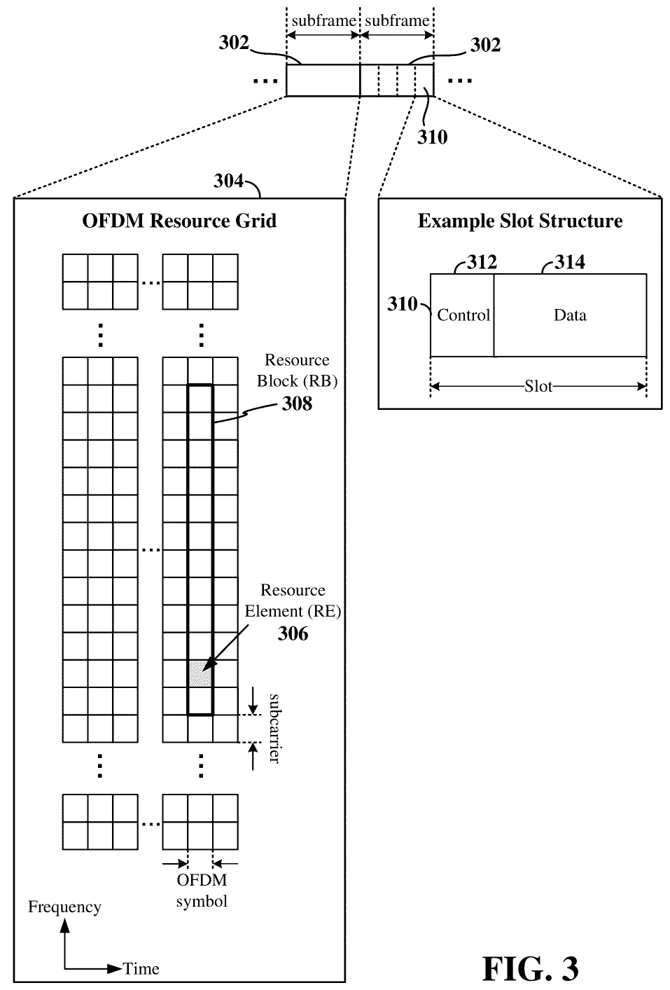

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgement (ACK) or negative acknowledgement (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESETO), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 3 are not necessarily all of the channels or carriers that may be utilized between devices, and those of ordinary skill in the art will recognize that other channels or carriers may be utilized in addition to those illustrated, such as other traffic, control, and feedback channels.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

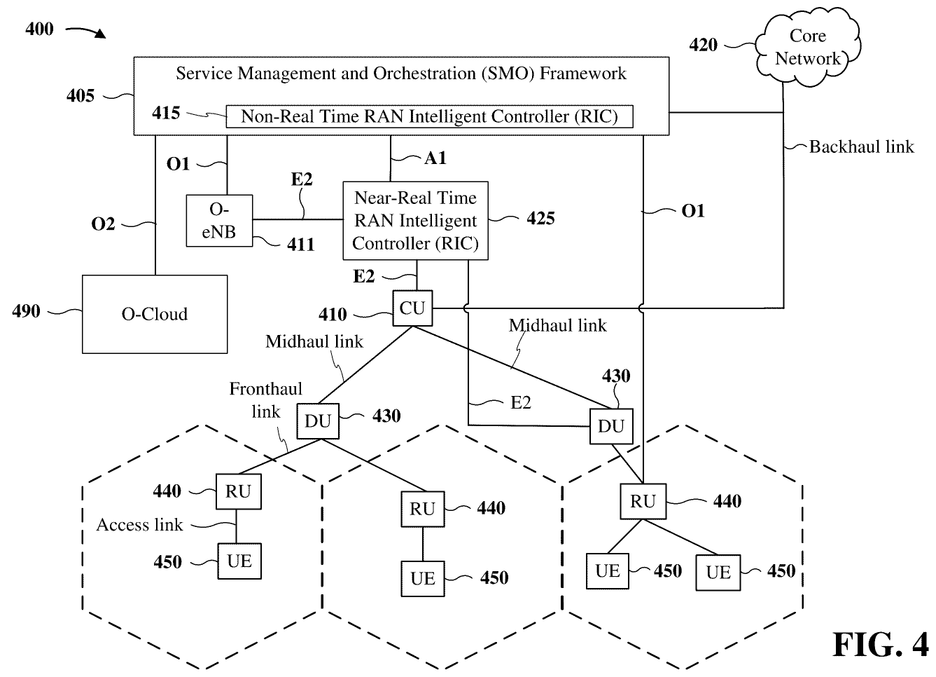

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUS) 440 via respective fronthaul links. The RUs 440 may communicate with respective UEs 450 via one or more radio frequency (RF) access links. In some implementations, the UE 450 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the El interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 450. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an Ol interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUS 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an Al interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

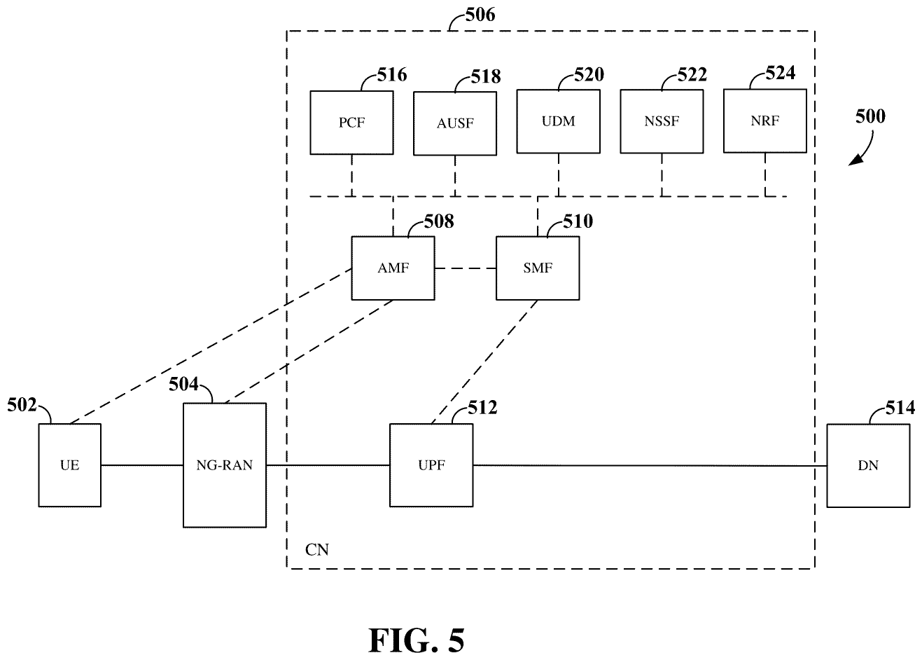

Referring now to FIG. 5, by way of example and without limitation, a block diagram illustrating an example of various components of a 5G wireless communication system (5GS) 500 is provided. In some examples, the 5GS 500 may correspond to the wireless communication system 100 described above and illustrated in FIG. 1. The 5GS 500 includes a user equipment (UE) 502, a NG-RAN 504, and a core network 506 (e.g., a 5G CN). The NG-RAN 504 may be a 5G RAN and correspond, for example, to the RAN 200 described above and illustrated in FIG. 2. In addition, the UE 502 may correspond to any of the UEs or other scheduled entities shown in FIG. 1 or 2. By virtue of the wireless communication system 500, the UE 502 may be enabled to carry out data communication with an external data network 514, such as (but not limited to) the Internet or an Ethernet network.

The core network 506 may include, for example, an access and mobility management function (AMF) 508, a session management function (SMF) 510, and a user plane function (UPF) 512. The AMF 508 and SMF 510 employ control plane (e.g., non-access stratum (NAS)) signaling to perform various functions related to mobility management and session management for the UE 502. For example, the AMF 508 provides connectivity, mobility management and authentication of the UE 502, while the SMF 510 provides session management of the UE 502 (e.g., processes signaling related to protocol data unit (PDU) sessions between the UE 502 and the external DN 514). The UPF 512 provides user plane connectivity to route 5G (NR) packets to/from the UE 502 via the NG-RAN 504.

As used herein, the term non-access stratum (NAS) may, for example, generally refer to protocols between the UE 502 and the core network 506 that are not terminated in the NG-RAN 504. In addition, the term access stratum may, for example, generally refer to a functional grouping consisting of the parts in the NG-RAN 504 and in the UE 502, and the protocols between these parts being specific to the access technique (i.e., the way the specific physical media between the UE 502 and the NG-RAN 504 is used to carry information).

The core network 506 may further include other functions, such as a policy control function (PCF) 516, authentication server function (AUSF) 518, unified data management (UDM) 520, network slice selection function (NSSF) 522, a network repository function (NRF) 524, and other functions (not illustrated, for simplicity). The PCF 516 provides policy information (e.g., rules) for control plane functions, such as network slicing, roaming, and mobility management. In addition, the PCF 516 supports 5G quality of service (QOS) policies, network slice policies, and other types of policies. The AUSF 518 performs authentication of UEs 502. The UDM 520 facilitates generation of authentication and key agreement (AKA) credentials, performs user identification and manages subscription information and UE context. The NSSF 522 redirects traffic to a network slice. Network slices may be defined, for example, for different classes of subscribers or use cases, such as smart home, Internet of Things (IoT), connected car, smart energy grid, etc. Each use case may receive a unique set of optimized resources and network topology (e.g., a network slice) to meet the connectivity, speed, power, and capacity requirements of the use case. The NRF 524 is a central repository for all of the 5G network functions (NFs) in the wireless communication system 500. The NRF 524 enables NFs to register and discover one another. In addition, the NRF 524 supports a 5G service-based architecture (SBA).

To establish a connection to the core network 506 (e.g., a 5G core network) via the NG-RAN 504, the UE 502 may transmit a registration request to the AMF 508 core network 506 via the NG-RAN 504. The AMF 508 may then initiate non access stratum (NAS) level authentication between the UE 502 and the core network 506 (e.g., via the AUSF 518 and UDM 520). The AMF 508 may then retrieve mobility subscription data, SMF selection data, and UE context and communicate with the PCF 516 for policy association for the UE 502. The AMF 508 may then send a NAS secure registration accept message to the UE 502 to complete the registration.

Once the UE 502 has registered with the core network 506, the UE 502 may transmit a PDU session establishment request to establish one or more PDU sessions to the core network 506 via the NG-RAN 504. The AMF 508 and SMF 510 may process the PDU session establishment request and establish a data network session (DNS) between the UE 502 and the external DN 514 via the UPF 512. A DNS may include one or more sessions (e.g., data sessions or data flows) and may be served by multiple UPFs 512 (only one of which is shown for convenience). Examples of data flows include, but are not limited to, IP flows, Ethernet flows and unstructured data flows.

In some examples, each PDU session may be associated with a respective network slice. The 5GS 500 may allow for multiple instances of a network slice (also referred to as network slice instances). For example, a network slice instance may include a set of network function instances and resources (e.g., compute, storage, and networking resources) which form a network slice. Each network slice instance may provide the network characteristics associated with a service or application supported by the 5GS 500.

In the 5GS 500, network slice selection assistance information (NSSAI) may refer to a collection of identifiers for network slices, where each identifier is referred to as single-network slice selection assistance information (S-NSSAI). In some examples, an S-NSSAI identity may include a slice/service type (SST) and a slice differentiator (SD). The SST may indicate the expected network slice behavior in terms of features and services, and the SD may be optionally used to differentiate among multiple network slices of the same SST. An S-NSSAI may have standard values or non-standard values. For example, an S-NSSAI with a standard value may mean that the S-NSSAI includes an SST with a standardized SST value. In one example, an SST value 1 may be associated with an eMBB network slice type, which may be suitable for handling 5G enhanced mobile broadband. In another example, an SST value 2 may be associated with a URLLC network slice type, which may be suitable for handling ultra-reliable low latency communications. In yet another example, an SST value 3 may be associated with an MIOT network slice type, which may be suitable for handling of massive IoT.

The UE 502 may request one or more S-NSSAIs when the UE 502 registers with the core network 506. For example, the UE 502 can transmit a radio resource control (RRC) message (Msg5) including an access stratum (AS)-requested NSSAI and a NAS registration request including the requested NSSAI. Here, an NSSAI includes a set of one or more S-NSSAI(s) Thus, the requested NSSAI may include, for example, the S-NSSAI(s) corresponding to the slice(s) to which the UE 502 is requesting to register. In some examples, the requested S-NSSAI(s) included in Msg5 may be a subset of the requested S-NSSAI(s) included in the NAS registration request message since Msg5 does not include security protection. The NG-RAN 504 can route the NAS registration request to the AMF 508, which may be selected using the requested NSSAI obtained from the AS message in Msg5. If the NG-RAN 504 is unable to select an AMF based on the requested NSSAI, the NG-RAN 504 may route the NAS registration request to an AMF from a set of default AMFs.

The AMF 508 may then respond with a NAS registration accept message including a list of allowed S-NSSAIs (allowed-NSSAI) and a list of rejected S-NSSAIs (rejected-NSSAI). The allowed NSSAI may include a minimum common set of the requested NSSAI (or default S-NSSAI(s) if no valid S-NSSAI is requested), the subscribed NSSAI, and the NSSAI supported by the current tracking area (TA) of the UE 502. In general, once a network slice is created, the slice is valid within a registration area (RA), which includes one or more tracking areas (TAs).

The AMF 508 verifies whether the S-NSSAI(s) in the requested NSSAI are permitted based on the subscribed S-NSSAIs in the UE context. In some examples, the AMF 508 may query the NSSF 522, with the requested NSSAI, the subscribed S-NSSAIs, the public land mobile network (PLMN) identifier (ID) of the NG-RAN 504, and other suitable information to retrieve the network slice instances (NSIs) to serve the UE 502. The AMF 508 may then include the permitted S-NSSAIs in the allowed-NSSAI and the not permitted S-NSSAIs in the rejected-NSSAI in the NAS registration accept message to the NG-RAN 504. The NG-RAN 504 may then forward the NAS registration accept message to the UE 502 within an RRC reconfiguration message to establish an RRC connection and a signaling radio bearer (SRB). A SRB is a logical communication channel on L2 and higher layers for the transfer of control information between the UE 502 and the NG-RAN 504. For example, the SRB may carry a dedicated control channel (DCCH) including physical (PHY) layer, medium access control (MAC) layer, and other access layer control information.

The UE 502 may then establish a PDU session associated with an S-NSSAI within the allowed-NSSAI. For example, the UE 502 may transmit a PDU session establishment request over NAS signaling to the core network 506 (e.g., the AMF 508). The PDU session establishment request may include the S-NSSAI and a data network name (DNN) of a DN 514 to which the PDU session is intended. SMF 510 discovery and selection within the selected NSI indicated by the S-NSSAI may then be initiated by the AMF 508. In some examples, the NRF 524 may assist the discovery and selection tasks of the required network functions for the selected NSI. For example, the AMF 508 may query the NRF 524 to select an SMF 510 in a NSI based on S-NSSAI, DNN and other information, e.g., UE subscription and local operator policies. The selected SMF 510 may then establish the PDU Session, which may include one or more quality of service (QoS) flows, with the DN 514 based on S-NSSAI and DNN. At the NAS level, a QoS flow is characterized by a QoS profile provided by the 5GC 506 to NG-RAN 504 and QoS rule(s) provided by 5GC 506 to the UE 502. The QoS profile is used by NG-RAN 504 to determine the treatment on the radio interface while the QoS rules dictate the mapping between uplink user plane traffic and QoS flows to the UE 502.

Upon establishing the PDU session, the NG-RAN 504 establishes one or more Data Radio Bearers (DRB) for the PDU Session. A DRB is a logical communication on L2 and higher layers for the transfer of data for the PDU session. For example, a DRB carries dedicated traffic channel (DTCH) data for a PDU session. A DRB may be established using a radio bearer (RB) setup procedure on the SRB. The NG-RAN 504 can map packets belonging to different PDU sessions to different DRBs. NAS level packet filters in the UE 502 and in the 5GC 506 can further associate uplink and downlink packets with QoS, and AS level mapping rules in the UE 502 and in the NG-RAN 504 can associate uplink and downlink QoS Flows with DRBs.

A UE may have multiple PDU sessions associated therewith, each associated with a respective network slice. Each network slice may be identified by a slice identifier (ID), a bearer ID, or a PDU session ID. In some examples, two or more network slices may be grouped together to form a network slice group. In this example, each network slice group may be identified by a slice group ID.

Some network slices may be restricted based on various factors, including, but not limited to, frequency, geographical area, time, or simultaneous usage of multiple (or specific combinations of) network slices. For example, a network slice may be supported in a serving cell, but not supported in one or more neighbor cells based on the frequencies of the neighbor cells, geographical area of the neighbor cells, time usage restrictions in the neighbor cells, or simultaneous usage restrictions in the neighbor cells.

In order to facilitate UE mobility with minimal interruption of slice services, various aspects are directed to supporting slice aware mobility. In some examples, slice aware mobility may be facilitated using slice specific measurement report configurations. In other examples, slice aware mobility may be facilitated using slice specific handover procedures. In some aspects, with slice aware mobility, signaling exchanges and service interruption time may be minimized for a network slice (e.g., when restrictions related to radio resources change, such as frequency, radio access technology (RAT), etc.). In addition, when a UE moves out of the service area of a network slice of an active application (e.g., PDU session), the impact on the active application may be minimized (e.g., by providing early notification).

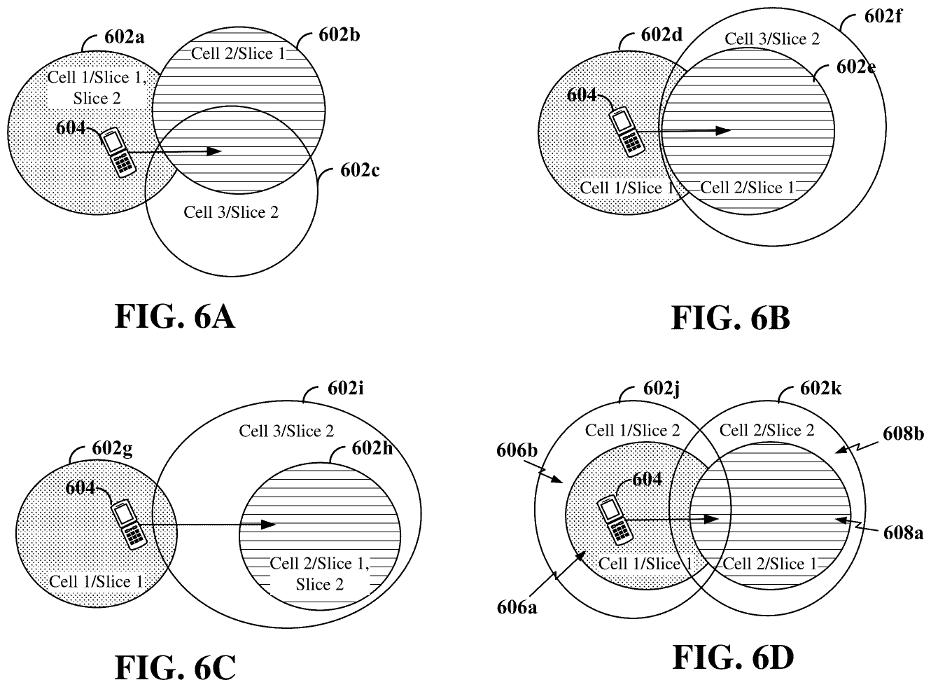

FIGS. 6A-6D illustrate example slice aware mobility scenarios according to some aspects. In the example shown in FIG. 6A, a UE 604 is shown located within a serving cell 602a (Cell 1). The UE 602 further has two simultaneous active applications (e.g., PDU sessions), each corresponding to a respective network slice (Slice 1 and Slice 2). The serving cell 602a supports each of the network slices (Slice 1 and Slice 2), as indicated by the shading in cell 602a. The UE 604 may further be moving from the serving cell 602a to a geographical area served by neighbor cells 602b and 602c. Neighbor cell 602b (Cell 2) supports Slice 1, whereas neighbor cell 602c (Cell 3) supports Slice 2.

In some examples, Slice 1 may have a higher priority than Slice 2. The priority of each slice may be determined, for example, by the UE 604 based on the priority of the associated PDU sessions. Using various slice aware mobility procedures related to cell measurement and handover, as described herein, the UE 604 may perform a handover to neighbor cell 602b, as shown by the hatching in cell 602b, to maintain the higher priority network slice (Slice 1). In addition, with slice aware mobility, the UE 604 may be notified that Slice 2 may be interrupted as a result of the handover to neighbor cell 602b.

In the example shown in FIG. 6B, the UE 604 is shown located within serving cell 602d (Cell 1) with a single active application (e.g., PDU session) corresponding to a network slice (Slice 1). The UE 604 is further shown moving from the serving cell 602d to a geographical area served by neighbor cells 602e and 602f. Neighbor cell 602e (Cell 2) supports only Slice 1, whereas neighbor cell 602f (Cell 3) supports only Slice 2. Neighbor cells 602e is contained within neighbor cell 602f to provide co-coverage within the area served by neighbor cells 602e and 602f. Using various slice aware mobility procedures related to cell measurement and handover, as described herein, the UE 604 may perform a handover to neighbor cell 602e, as shown by the hatching in cell 602e, to maintain Slice 1.

In the example shown in FIG. 6C, the UE 604 is shown located within serving cell 602g (Cell 1) with a single active application (e.g., PDU session) corresponding to a network slice (Slice 1). The UE 604 is further shown moving from the serving cell 602g to a geographical area served by neighbor cells 602h and 602i. Neighbor cell 602h (Cell 2) supports two network slices (Slice 1 and Slice 2), whereas neighbor cell 602i (Cell 3) supports only Slice 2. Neighbor cells 602h is contained within neighbor cell 602i to provide co-coverage within the area served by neighbor cells 602h and 602i. Using various slice aware mobility procedures related to cell measurement and handover, as described herein, the UE 604 may perform a handover to neighbor cell 602h, as shown by the hatching in cell 602h, to maintain Slice 1. However, there is no overlap between the serving cell 602g and neighbor cell 602h. Therefore, Slice 1 is discontinuous, being deployed in only the serving cell 602g and the neighbor cell 602h. As a result, the UE 604 may first perform a handover to neighbor cell 602i, resulting in a temporary interruption of Slice 1, and then perform a handover from cell 602i to neighbor cell 602h to re-establish the PDU session associated with Slice 1.

In the example shown in FIG. 6D, the UE 604 is shown located within serving cell 602j (Cell 1) with a single active application (e.g., PDU session) corresponding to a network slice (Slice 1). The serving cell 602j is configured to provide different coverage areas for different network slices. For example, the serving cell 602j may include a first coverage area 606a for Slice 1 and a second coverage area 606b for Slice 2. The UE 604 is further shown moving from the serving cell 602j to a geographical area served by neighbor cell 602k. Neighbor cell 602k (Cell 2) is also configured to provide different coverage areas for different network slices. For example, neighbor cell 602k may include a first coverage area 608a for Slice 1 and a second coverage area 608b for Slice 2. Using various slice aware mobility procedures related to cell measurement and handover, as described herein, the UE 604 may perform a handover to neighbor cell 602k, as shown by the hatching in cell 602k, to maintain Slice 1 as long as UE 604 moves within the first coverage area 608a of neighbor cell 602k for Slice 1.

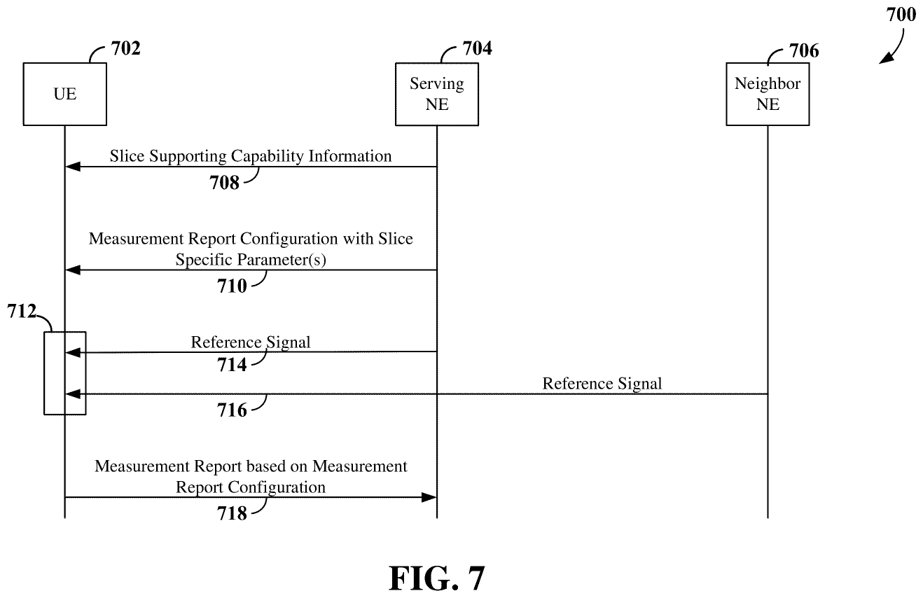

FIG. 7 is a signaling diagram illustrating exemplary signaling 700 between a UE 702, a serving network entity 704 (e.g., a network entity associated with a serving cell), and a neighbor network entity 706 (e.g., a network entity associated with a candidate/neighbor cell) for slice specific measurement reporting according to some aspects. The UE 702 may correspond, for example, to any of the UEs or other scheduled entities shown in FIGS. 1, 2, and/or 4-6. The serving and neighbor network entities 704 and 706 may correspond, for example, to any of the network entities (e.g., a base station or gNB in an aggregated base station architecture, or a central unit (CU), a distributed unit (DU), a radio unit (RU), a Near-Real Time (Near-RT) RAN Intelligent Controller (RIC), or a Non-Real Time (Non-RT) RIC in a disaggregated base station architecture) shown in FIGS. 1, 2, and/or 4-6.

At 708, the serving network entity (NE) 704 may transmit slice supporting capability information to the UE 702. The slice supporting capability information may indicate, for example, respective network slices supported by each of a plurality of neighbor cells or frequencies of neighbor cells. In some examples, the slice supporting capability information may be transmitted to the UE 702 using, for example, a SIB or other dedicated signaling per cell, per frequency, or per Registration Area. For example, the serving NE 704 may transmit an RRC message (e.g., SIB or other dedicated signaling) to the UE 702 including the slice supporting capability information.

At 710, the serving network entity (NE) 704 may transmit a measurement report configuration to the UE 702. For example, the measurement report configuration may be transmitted to the UE 702 via a radio resource control (RRC) message. The measurement report configuration may include one or more measurement objects and one or more slice specific parameters for measuring the signal quality of the serving cell and/or one or more neighbor cells. Each measurement object (meas object) may indicate the time-frequency location and sub-carrier spacing of reference signals, such as SSBs and/or CSI-RSs, of the serving cell and/or one or more neighbor cells, to be measured. Each slice specific parameter may be associated with a respective set of one or more network slices (e.g., a single network slice or a slice group).

The measurement report configuration may further configure the UE 702 to send periodic measurement reports to the serving NE 704 or to send event-triggered measurement reports to the serving NE 704. For periodic measurement reports, the slice specific parameter(s) may include, for example, a report interval of an associated periodic measurement report and/or a report amount indicating a number of signal quality measurements (e.g., reference signal received power (RSRP), reference signal received quality (RSRQ), and/or signal-to-interference-plus noise ratio (SINR)) to be included in the periodic measurement report.

For example, for each network slice (or network slice group), the measurement report configuration may include a respective report interval for respective periodic measurement reports. In an example, for a first network slice, the measurement report configuration may indicate that periodic measurement reports should be sent by the UE 702 every 100 ms, whereas for a second network slice, the measurement report configuration may indicate that periodic measurement reports should be sent by the UE 702 every 200 ms. In an example, for a first slice (Slice 1), the measurement report configuration may configure the UE 702 to report measurement results (e.g., RSRP, RSRQ, and/or SINR) each slice specific report interval for the neighbor cells that support Slice 1. In other examples, the measurement report configuration may configure the UE 702 to report measurement results (e.g., RSRP, RSRQ, and/or SINR) each slice specific report interval for all neighbor cells irrespective of whether the neighbor cells support Slice 1 (e.g., both cells that are supportive of Slice 1 and cells that are unsupportive of Slice 1). In some examples, the measurement report configuration may further include a common parameter (e.g., common report interval) applicable to other network slices (e.g., other than Slice 1). In this example, the measurement report configuration may configure the UE 702 to report measurement results (e.g., RSRP, RSRQ, and/or SINR) each common report interval for the neighbor cells unsupportive of Slice 1 (e.g., neighbor cells that do not support Slice 1).

As another example, for each network slice (or network slice group), the measurement report configuration may include a respective report amount to be included in a periodic measurement report. In an example, for the first network slice, the measurement report configuration may indicate that the UE 702 should send the measured RSRP of the serving cell and/or one or more neighbor cells in the periodic measurement report, whereas for the second network slice, the measurement report configuration may indicate that the UE 702 should send the measured RSRP and SINR of the serving cell and/or one or more neighbor cells in the periodic measurement report. In an example, for a first slice (Slice 1), the measurement report configuration may configure the UE 702 to report the slice specific measurement results (e.g., RSRP, RSRQ, and/or SINR) for the neighbor cells that support Slice 1. In other examples, the measurement report configuration may configure the UE 702 to report the slice specific measurement results (e.g., RSRP, RSRQ, and/or SINR) for all neighbor cells irrespective of whether the neighbor cells support Slice 1 (e.g., both cells that are supportive of Slice 1 and cells that are unsupportive of Slice 1). In some examples, the measurement report configuration may further include a common parameter (e.g., common report amount) applicable to other network slices (e.g., other than Slice 1). In this example, the measurement report configuration may configure the UE 702 to report common measurement results (e.g., RSRP, RSRQ, and/or SINR) for the neighbor cells unsupportive of Slice 1 (e.g., neighbor cells that do not support Slice 1).

For event-triggered measurement reports, the at least one slice specific parameter may be associated with at least one event. For example, the measurement report configuration may configure one or more events for triggering the transmission of a measurement report from the UE 702 to the serving NE 704. Each event may include one or more parameters. In some examples, one or more of the parameters of an event may be a slice specific parameter. In this example, the measurement report configuration may configure the UE 702 to report measurement results (e.g., RSRP, RSRQ, and/or SINR) for the neighbor cells that support Slice 1 or for all neighbor cells irrespective of whether the neighbor cells support Slice 1 upon the occurrence of event based on the slice specific parameter(s) associated with the event. For example, the UE 702 may use the slice specific parameter(s) of a particular event to evaluate the event for each neighboring cell or for only those cells that support Slice 1 to determine whether to send a measurement report. In some examples, the serving NE 704 may configure both a slice specific parameter (e.g., for Slice 1) and a common parameter of the same parameter type for a particular event. In this example, the UE 702 may use the common parameter to evaluate the event for neighboring cells that are unsupportive of Slice 1. As another example, the serving NE 704 may configure a common parameter for a particular parameter type and may then configure an offset to the common parameter to indicate the slice specific parameter.

At 712, the UE 702 may enter a measurement phase for measuring the signal quality of the serving cell and/or neighbor cells. In the example shown in FIG. 7, during the measurement phase, at 714 and 716, the UE 702 may receive a respective reference signal (e.g., SSB or CSI-RS) from the serving NE 704 and at least one candidate NE 706. The UE 702 may then obtain one or more respective measurements (e.g., RSRP, RSRQ, and/or SINR) for each of the serving NE 704 and the candidate NE 706 based on the measurement report configuration. For example, for periodic measurement reports, the UE 702 may obtain the slice specific report amount indicated by the measurement report configuration based on the reference signals transmitted each of the serving NE 704 and the neighbor NE 706. As another example, for event-triggered measurement reports, the UE 702 may obtain the measurement(s) indicated in the measurement report configuration for a particular event based on the reference signal(s) transmitted by the serving NE 704 and/or neighbor NE 706.

At 718, the UE 702 may transmit a measurement report based on the measurement report configuration. For example, for periodic measurement reports, the UE 702 may transmit the measurement report based on the slice specific report interval and/or may include the slice specific report amount of measurements within the measurement report. As another example, for event-triggered measurement reports, the UE 702 may evaluate a particular event using the slice specific parameter(s) for that event and then transmit the measurement report upon triggering of the particular event.

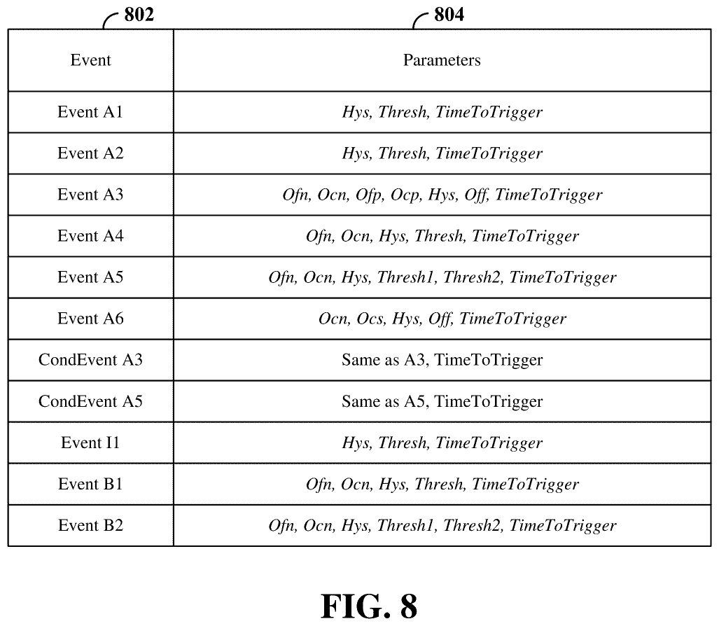

FIG. 8 is a diagram illustrating exemplary events 802 and associated parameters 804 for triggering a measurement report according to some aspects. The events 802 shown in FIG. 8 include Event A1, Event A2, Event A3, Event A4, Event A5, Event A6, CondEvent A3, CondEvent A5, Event I1, Event B1, and Event B2. For example, Event A1 may be triggered when the signal quality of the serving cell is greater than a threshold. Event A1 may be used, therefore, to cancel an ongoing handover. Event A1 includes the following parameters 804: Hys, Thresh, and TimeToTrigger, where the Thresh refers to a threshold for triggering the measurement report and Hys refers to a hysteresis value between 0 and 30. The actual hysteresis value in dB may be obtained by multiplying 0.5 with the Hys value. Event A1 may be triggered in examples in which the difference between the measured RSRP of the serving cell and the hysteresis is greater than the threshold or when the summation of the measured RSRP and the hysteresis is less than the threshold. As another example, Event A2 may triggered when the signal quality of the serving cell is less than a threshold. Event A2 may be used, therefore, to trigger neighbor cell measurements as the UE moves towards a cell edge.

Event A3 may be triggered when the signal quality of a neighbor cell is greater than a special cell (SpCell) by an offset amount. Here, a SpCell refers to the primary serving cell of either a Master Cell Group (MCG) or a Secondary Cell Group (SCG). The offset can be either positive or negative. This event can be used for intra-frequency or inter-frequency handover procedures. Event A3 includes the following parameters 804: Ofn, Ocn, Ofp, Ocp, Hys, Off, and TimeToTrigger, where Ofn refers to the measurement object specific offset of the reference signal of the neighbor cell, Ocn is the cell specific offset of the neighbor cell, Ofp is the measurement object specific offset of the SpCell, Ocp is the cell specific offset of the SpCell, Hys refers to a hysteresis value, and Off refers to the offset parameter for the Event. Event A3 may be triggered in examples in which the difference between the hysteresis and the summation of the measured RSRP of the neighbor cell, Ofn and Ocn is greater than the summation of the measured RSRP of the SpCell, Ofp, Ocp, and Off.

As another example, Event A4 may be triggered when the signal quality of a neighbor cell is greater than a threshold. Event A4 may, therefore, be used for handover procedures that do not depend upon the coverage of the serving cell. Event A4 includes the following parameters 804: Ofn, Ocn, Hys, Thresh, and TimeToTrigger, where Ofn refers to the measurement object specific offset of the reference signal of the neighbor cell, Ocn is the cell specific offset of the neighbor cell, Hys refers to a hysteresis value, and Thresh refers to threshold for the Event. Event A4 may be triggered in examples in which the difference between the hysteresis and the summation of the measured RSRP of the neighbor cell, Ofn and Ocn is greater than the threshold.

Other events 802 utilize similar parameters 804 to trigger a measurement report. For example, Event A5 may be triggered when the signal quality of the SpCell is less than a first threshold (Thresh1) and the signal quality of a neighbor cell is greater than a second threshold (Thresh2). Event A5 may be used for intra-frequency or inter-frequency handover procedures to trigger a time critical handover when the signal quality in the current SpCell becomes low and it is necessary to handover to another cell that may not satisfy the criteria for an Event A3 handover. Event A6 may be triggered when the signal quality of a neighbor cell is greater than a secondary cell by an offset amount. Event A6 measurement reporting may be applicable, for example, to carrier aggregation in which secondary serving cells may be added to a primary serving cell. Events A1-A6 including condEvent A3 and condEvent A5, as described above, refer to intra-RAT events, whereas the remaining events refer to inter-RAT events similar to the intra-RAT events.

In some aspects, one or more of the parameters 804 for one or more of the events 802 may be slice specific parameters. In an example, the network entity may configure Event A3 to a UE and configure normal parameters for Ofn, Ocn, Ofp, Ocp, and Off, a slice specific parameter Hys-1 for Slice 1, and a common parameter Hys for Event A3. In this example, the UE has an ongoing service for Slice 1. The UE may then perform an A3 event evaluation using Hys-1 for each neighbor cell supporting Slice 1. In addition, the UE may evaluate the A3 event using Hys for all neighbor cells unsupportive of Slice 1. In some examples, instead of configuring Hys-1, the network entity can configure an offset to the common parameter Hys to indicate the slice specific parameter. In examples in which the common parameter Hys is not configured, the UE may perform an Event A3 evaluation using Hys-1 for all neighbor cells irrespective of whether the neighbor cells support Slice 1.

In addition to or as an alternative to slice specific measurement report configurations, slice aware mobility may further be enabled using slice specific handover procedures. For example, a 5G network may be configured to use a slice specific conditional handover procedure or a slice specific network-initiated handover procedure.

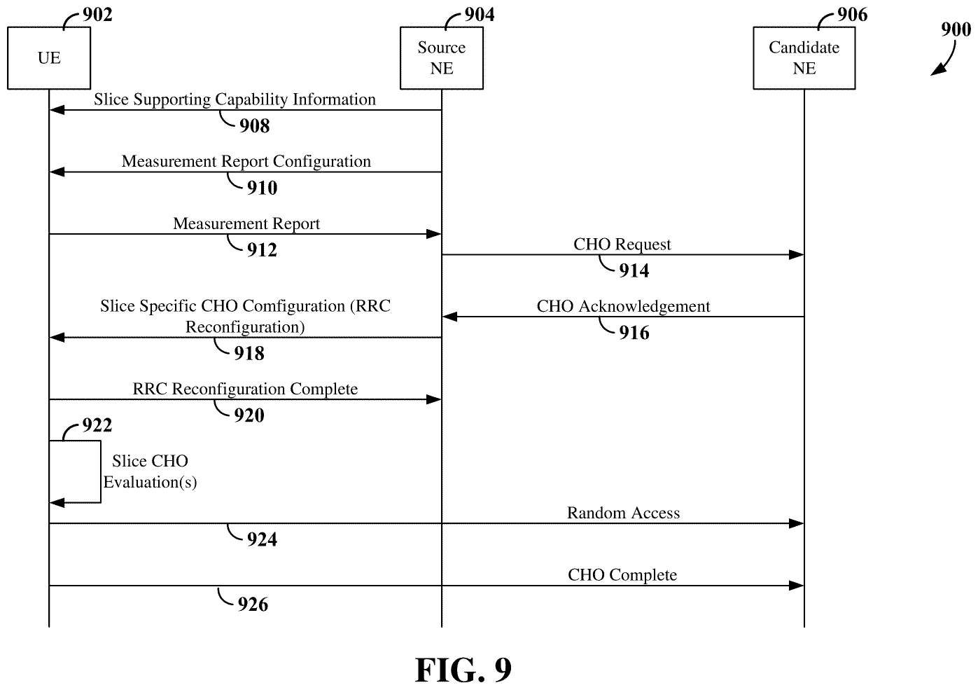

FIG. 9 is a signaling diagram illustrating exemplary signaling 900 for a slice specific conditional handover of a UE 902 from a source (serving) NE 904 to a candidate (target) NE 906 according to some aspects. The UE 902 may correspond, for example, to any of the UEs or other scheduled entities shown in FIGS. 1, 2, and/or 4-7. The network entities 904 and 906 may correspond, for example, to any of the network entities (e.g., a base station or gNB in an aggregated base station architecture, or a central unit (CU), a distributed unit (DU), a radio unit (RU), a Near-Real Time (Near-RT) RAN Intelligent Controller (RIC), or a Non-Real Time (Non-RT) RIC in a disaggregated base station architecture) shown in FIGS. 1, 2, and/or 4-7.

At 908, the source network entity (NE) 904 may transmit slice supporting capability information to the UE 902. The slice supporting capability information may indicate, for example, respective network slices supported by each of a plurality of neighbor cells or frequencies of neighbor cells. In some examples, the slice supporting capability information may be transmitted to the UE 902 using, for example, a SIB or other dedicated signaling per cell, per frequency, or per Registration Area. For example, the source NE 904 may transmit an RRC message (e.g., SIB or other dedicated signaling) to the UE 902 including the slice supporting capability information.

At 910, the source NE 904 may transmit a measurement report configuration to the UE 902. For example, the measurement report configuration may be transmitted to the UE 902 via a radio resource control (RRC) message. The measurement report configuration may include one or more measurement objects for measuring the signal quality of the serving cell and/or one or more neighbor cells. Each measurement object (meas object) may indicate the time-frequency location and sub-carrier spacing of reference signals, such as SSBs and/or CSI-RSs, of the serving cell and/or one or more neighbor cells, to be measured. In some examples, as described above in connection with FIG. 7, the measurement report configuration may further include one or more slice specific parameters.

At 912, the UE 902 may generate and transmit a measurement report based on the measurement report configuration to the source NE 904. The measurement report may include, for example, at least one respective signal quality measurement (e.g., RSRP, RSRQ, SINR) of a serving cell served by the source NE 904 and/or one or more neighbor cells, at least one of which may be served by the candidate NE 906.

At 914, the source NE 904 may perform handover preparation procedures with one or more candidate NEs 906 (one of which is shown for convenience) to prepare for a potential future handover of the UE 902 from the source NE 904 to a candidate cell served by one of the candidate NEs 906. For example, the source NE 904 may transmit a conditional handover (CHO) request message to the candidate NE 906. In some examples, the source NE 904 may select the candidate cells for a CHO based on the ongoing network slices of the UE 902. For example, the source NE 904 may receive slice supporting capability information from, for example, a core network (e.g., an AMF). The slice supporting capability information may indicate, for example, respective network slices supported by each of a plurality of neighbor cells. In addition, the source NE 904 may further receive slice information indicating the ongoing network slices of the UE 902 from the core network (e.g., the AMF), the UE 902, and/or a previous (last) serving NE (not shown) of the UE 902. For example, the slice information may include a slice ID, bearer ID, or PDU session ID associated with each ongoing network slice. In examples in which the network slices are organized into slice groups, the slice information may include a slice group ID. Based on the slice supporting capability information and the slice information, the source NE 904 may select the candidate cells to which to send a CHO request message.

At 916, the candidate NE 906 may respond with a CHO acknowledgement message, which may include a CHO configuration for use by the source NE 904 in generating a CHO command for the UE 902. For example, the CHO configuration may include a RACH configuration for the candidate NE 906 providing resources for performing a random-access procedure with the candidate NE 906.

At 918, the source NE 904 generates and transmits a slice specific CHO configuration to the UE 902. For example, the source NE 904 may transmit a RRCReconfiguration message including the slice specific CHO configuration to the UE 902. The slice specific CHO configuration may include, for example, a list of neighbor cells (e.g., which may include a list of neighbor cells per ongoing network slice) to which the UE 902 may perform a handover, one or more triggering conditions (e.g., which may include triggering conditions per ongoing network slice) for triggering the handover, a measurement configuration (e.g., measurement object) to enable the UE 902 to select the best candidate cell, and a respective random access channel (RACH) configuration for each of the candidate cells.

For example, the slice specific CHO configuration may include at least one candidate target cell that supports an ongoing network slice of the UE 902. In examples in which the UE 902 has multiple ongoing network slices, the slice specific CHO configuration may include a respective set of one or more candidate target cells for each ongoing network slice or for a portion of the ongoing network slices. In this example, the slice specific CHO configuration may include a respective slice specific CHO configuration for each ongoing network slice (or portion thereof). As another example, the slice specific CHO configuration may include a slice specific execution condition associated with a particular network slice for executing a handover to a target cell (e.g., a cell served by candidate NE 906). In examples in which the UE 902 has multiple ongoing network slices, the slice specific CHO configuration may include a respective slice specific execution condition for each ongoing network slice or for a portion of the ongoing network slices. In this example, the slice specific CHO configuration may include a respective slice specific CHO configuration for each ongoing network slice (or portion thereof).

In some examples, the source NE 904 may determine the slice specific CHO configuration based on the slice information indicating the ongoing network slices of the UE 902. In some examples, the slice specific CHO configuration provided to the UE 902 may further include the slice information. In some examples, the slice information received by the source NE 904 may further include priority information indicating a respective priority of each of the ongoing network slices. The source NE 904 may select the candidate target cell(s) and/or execution conditions for each of the ongoing network slices based on the respective priorities of the ongoing network slices.

In examples in which the UE 902 has multiple ongoing network slices, the source NE 904 may transmit a plurality of slice specific CHO configurations to the UE 902. Each slice specific CHO configuration may be associated with a respective set of one or more network slices (e.g., a network slice or network slice group). In examples in which each network slice has a respective priority associated therewith, the source NE 904 may indicate a priority or order of each of the plurality of slice specific CHO configurations according to the ongoing network slice priority information.

The UE 902 may store the slice specific CHO configuration and monitor for a CHO condition associated with the candidate cells. At 920, the UE 902 generates and transmits an RRCReconfigurationComplete message to the source NE 904 acknowledging receipt of the slice specific CHO configuration.

At 922, the UE 902 may perform a CHO condition evaluation based on the slice specific CHO configuration to determine whether a triggering CHO condition has been satisfied. For example, using the additional measurement configuration, the UE 902 may determine that the signal strength or link quality of a candidate cell of the candidate NE 906 exceeds that of the serving cell of the source NE 904 for a predetermined amount of time or is an offset better than that of the serving cell.

In examples in which the UE 902 has multiple ongoing network slices, the UE may perform a respective CHO condition evaluation for each network slice. For example, the slice specific CHO configuration may include a respective slice specific CHO configuration for each ongoing network slice. The UE 902 may perform a respective CHO condition evaluation in accordance with each slice specific CHO configuration. In examples in which the source NE 904 has indicated a priority or order of slice specific CHO configurations, the UE 902 may perform CHO condition evaluations based on the order or priority of slice specific CHO configurations.

Upon determining that a triggering condition of one or more of the slice specific CHO configurations has been met, the UE 902 may select a candidate cell to which to perform a conditional handover. In some examples, the UE 902 may select a candidate cell configured to the highest priority network slice(s) for which a triggering condition has been met. For example, the UE 902 may maintain the respective priority of each of the network slices (e.g., based on the priorities of the associated applications or services), and select a candidate cell supporting the highest priority network slice(s) for which a triggering condition has been met. In other examples, the UE 902 may retrieve the respective priority of each of the network slices via, for example, NAS layer signaling, from the core network (e.g., the AMF). For example, if the bearer ID or the PDU session ID is indicated to the UE 902 in the slice specific CHO configuration, the UE 902 may obtain the slice information (e.g., slice ID), and in some examples, the slice priority, from the NAS layer corresponding to the PDU session.

In examples in which the source NE 904 has indicated the respective priority of each slice specific CHO configuration (e.g., based on the ongoing network slice priorities) or the source NE 904 has indicated a respective order of the slice specific CHO configurations (e.g., based on the ongoing network slice priorities), the UE 902 may perform the CHO condition evaluations based on the priority/order and then select a candidate cell to which to perform a conditional handover based on the first triggered CHO condition evaluation. For example, if the UE receives three slice specific CHO configurations and is provided an order of a first CHO configuration, a second CHO configuration, and a third CHO configuration, the UE 902 may perform a CHO condition evaluation for the first CHO configuration. If the triggering condition(s) of the first CHO configuration are not met, the UE 902 may then perform a CHO condition evaluation for the second CHO configuration. If the triggering condition(s) of the second CHO configuration are met, the UE 902 may select a candidate cell based on the second CHO configuration (e.g., from the list of candidate cells included in the second CHO configuration and further based on the satisfied triggering condition(s)).

In examples in which the selected candidate cell is unsupportive of one or more other lower priority network slices, the UE 902 may interrupt service to the one or more other lower priority network slices. In this example, the UE 902 may determine that the selected candidate cell is unsupportive of the one or more other lower priority network slices based on the slice supporting capability information, thereby providing early notification to the UE 902 of the interruption in service, which can minimize the impact on the affected active applications.

At 924, the UE 902 may then detach from the source NE 904 and synchronize to the candidate NE 906 by performing a random-access procedure (e.g., using the RACH configuration in the CHO command) with the candidate NE 906. At 926, the UE 902 may transmit a CHO complete message to connect to the candidate NE 906.

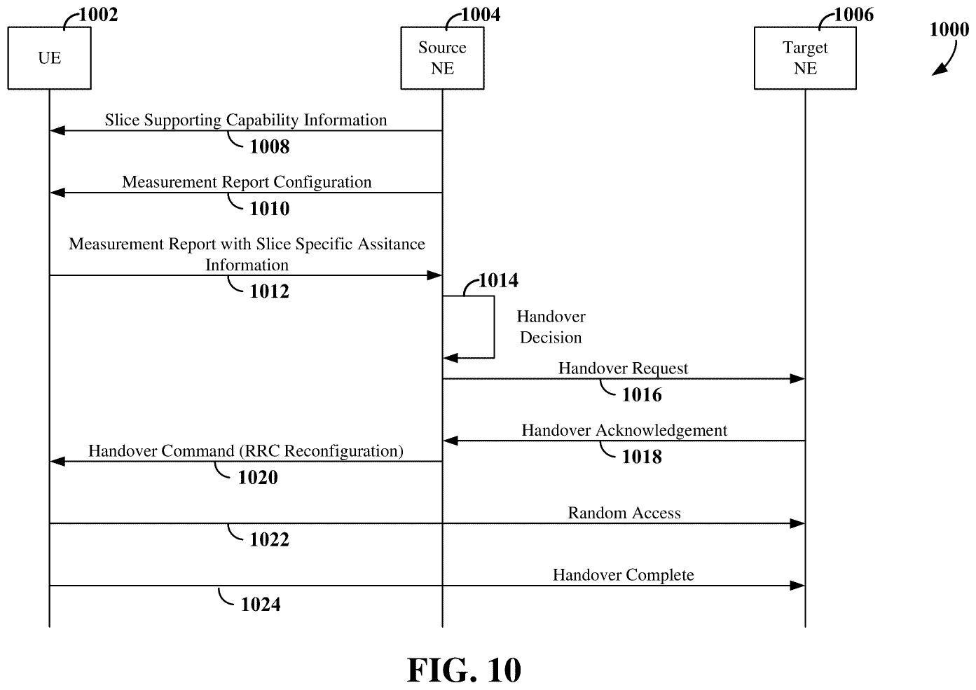

FIG. 10 is a signaling diagram illustrating exemplary signaling 1000 for a slice specific network-initiated handover of a UE 1002 from a source (serving) NE 1004 to a target NE 1006 according to some aspects. The UE 1002 may correspond, for example, to any of the UEs or other scheduled entities shown in FIGS. 1, 2, and/or 4-7. The network entities 1004 and 1006 may correspond, for example, to any of the network entities (e.g., a base station or gNB in an aggregated base station architecture, or a central unit (CU), a distributed unit (DU), a radio unit (RU), a Near-Real Time (Near-RT) RAN Intelligent Controller (RIC), or a Non-Real Time (Non-RT) RIC in a disaggregated base station architecture) shown in FIGS. 1, 2, and/or 4-7.

At 1008, the source network entity (NE) 1004 may transmit slice supporting capability information to the UE 1002. The slice supporting capability information may indicate, for example, respective network slices supported by each of a plurality of neighbor cells or frequencies of neighbor cells. In some examples, the slice supporting capability information may be transmitted to the UE 1002 using, for example, a SIB or other dedicated signaling per cell, per frequency, or per Registration Area. For example, the source NE 1004 may transmit an RRC message (e.g., SIB or other dedicated signaling, such as dedicated RRC signaling) to the UE 1002 including the slice supporting capability information.

At 1010, the source NE 1004 may transmit a measurement report configuration to the UE 1002. For example, the measurement report configuration may be transmitted to the UE 1002 via a radio resource control (RRC) message. The measurement report configuration may include one or more measurement objects for measuring the signal quality of the serving cell and/or one or more neighbor cells. Each measurement object (meas object) may indicate the time-frequency location and sub-carrier spacing of reference signals, such as SSBs and/or CSI-RSs, of the serving cell and/or one or more neighbor cells, to be measured.

At 1012, the UE 1002 may generate and transmit a measurement report with slice specific assistance information based on the measurement report configuration to the source NE 1004. The measurement report may include, for example, at least one respective signal quality measurement (e.g., RSRP, RSRQ, SINR) of a serving cell served by the source NE 1004 and/or one or more neighbor cells, at least one of which may be served by the candidate NE 1006. The slice specific assistance information may assist the source NE 1004 in selecting candidate target cells for a handover.

In some examples, the slice specific assistance information may include the measurement results of the cells (e.g., serving cell and/or one or more neighbor cells) that support an ongoing network slice of the UE 1002. The UE 1002 may use the slice supporting capability information to determine the neighbor cells that support the ongoing network slice and report measurement results for only those cells that support the ongoing network slice. For example, the slice specific assistance information may indicate one or more neighbor cells supporting the ongoing network slice that have a respective highest (or best) measurement result (e.g., RSRP, RSRQ, SINR). In an example, the measurement report configuration may configure the UE 1002 to report the highest measurement result associated with the best neighbor cell for the ongoing network slice.

In examples in which the UE 1002 has multiple ongoing network slices and the UE 1002 is configured with a respective priority for each network slice (e.g., based on the corresponding priorities of the associated applications and/or retrieved from the core network via NAS layer signaling), the slice specific assistance information may further include the respective priority of each network slice. In addition, the slice specific assistance information may further include the highest measurement result(s) associated with the best neighbor cell(s) for each of the ongoing network slices.

At 1014, the source NE 1004 may determine to perform a handover of the UE 1002 and select a target cell to which to perform the handover based on the measurement report. For example, the source NE 1004 may identify at least one candidate target cell for a handover of the ongoing network slice(s) based on the slice specific assistance information included in the measurement report. The source NE 1004 may then select the target cell (e.g., served by the target NE 1006) from the at least one candidate target cell. In examples in which the UE 1002 has multiple ongoing network slices, a respective target cell for each ongoing network slice may be identified and the source NE 1004 may select the target cell corresponding to the highest priority network slice. In other examples, the identified candidate target cells may correspond to cells that support one or more of the ongoing network slices and the source NE 1004 may select the target cell based on the respective priorities of the ongoing network slices and the number of ongoing network slices that each candidate target cell supports.

At 1016, the source NE 1004 may transmit a handover request to the target NE 1006. At 1018, the target NE 1006 may respond with a handover acknowledgement message, which may include a handover configuration for use by the source NE 1004 in generating a handover command for the UE 1002. For example, the handover configuration may include a RACH configuration for the target NE 1006 providing resources for performing a random-access procedure with the target NE 1006.

At 1020, the source NE 1004 may transmit a handover command to the UE 1002. For example, the source NE 1004 may transmit a RRCReconfiguration message including the handover command to the UE 1002. The handover command may include, for example, a RACH configuration for the target NE 1006. In examples in which the target cell is unsupportive of one or more other lower priority network slices, the UE 1002 may interrupt service to the one or more other lower priority network slices. In this example, the UE 1002 may determine that the selected target cell is unsupportive of the one or more other lower priority network slices based on the slice supporting capability information, thereby providing early notification to the UE 1002 of the interruption in service, which can minimize the impact on the affected active applications.

At 1022, the UE 1002 may then detach from the source NE 1004 and synchronize to the target NE 1006 by performing a random-access procedure (e.g., using the RACH configuration in the handover command) with the target NE 1006. At 1024, the UE 1002 may transmit a handover complete message to connect to the target NE 1006.

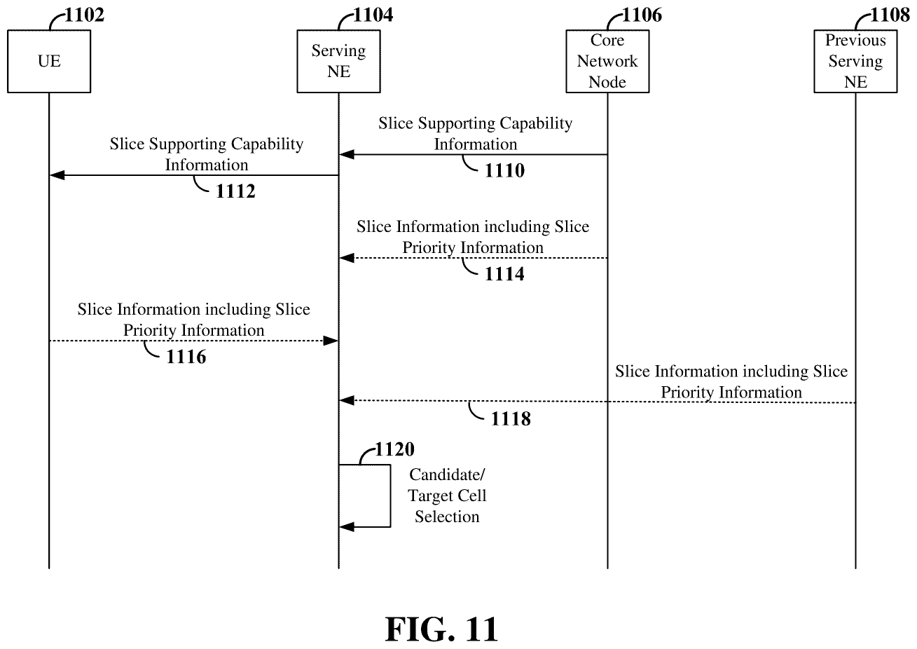

FIG. 11 is a signaling diagram illustrating exemplary signaling 1100 between a UE 1102, a serving NE 1104, a core network node 1106, and a previously serving NE 1108 to select one or more candidate cells for a handover based on slice specific information according to some aspects. The UE 1102 may correspond, for example, to any of the UEs or other scheduled entities shown in FIGS. 1, 2, 4-7, 9 and/or 10. The network entities 1104 and 1108 may correspond, for example, to any of the network entities (e.g., a base station or gNB in an aggregated base station architecture, or a central unit (CU), a distributed unit (DU), a radio unit (RU), a Near-Real Time (Near-RT) RAN Intelligent Controller (RIC), or a Non-Real Time (Non-RT) RIC in a disaggregated base station architecture) shown in FIGS. 1, 2, 4-7, 9 and/or 10. The core network node 1106 may correspond, for example, to an AMF or other core network node as shown in FIGS. 1 and/or 5.

At 1110, the core network node 1106 may transmit slice supporting capability information to the serving NE 1104. The slice supporting capability information may indicate, for example, respective network slices supported by each of a plurality of neighbor cells or frequencies of neighbor cells. At 1112, the serving NE 1104 may further transmit the slice supporting capability information to the UE 1102. In some examples, the slice supporting capability information may be transmitted to the UE 1002 using, for example, a SIB or other dedicated signaling per cell, per frequency, or per Registration Area. For example, the source NE 1104 may transmit an RRC message (e.g., SIB or other dedicated signaling) to the UE 1102 including the slice supporting capability information.

At 1114-1116, the serving NE 1104 may receive slice information including slice priority information associated with ongoing network slices of the UE 1102. In some examples, as indicated at 1114, the serving NE 1104 may receive the slice information including the slice priority information from the core network node 1106. For example, the core network node 1106 may provide the slice information including the slice priority information to the serving NE 1104 using a NG Application Protocol (NGAP) procedure (e.g., a PDU session management procedure). In other examples, as indicated at 1116, the serving NE 1104 may receive the slice information including the slice priority information from the UE 1102. For example, the UE 1102 may provide the slice information including the slice priority information to the serving NE 1104 within a measurement report (MeasurementReport message), within UEAssitanceInformation or via another RRC message. In still other examples, as indicated at 1118, the serving NE 1104 may receive the slice information including the slice priority information from the previously serving NE 1108. For example, the previously serving NE 1108 may provide the slice information including the slice priority information to the serving NE 1104 during handover of the UE 1102 from the previously serving NE 1108 or UE context retrieve procedure.

The slice information may include a slice ID, bearer ID, or PDU session ID associated with each ongoing network slice of the UE 1102. In examples in which the network slices are organized into slice groups, the slice information may include a slice group ID. The slice priority information may include a respective priority associated with each of the ongoing slices (or a portion thereof). In some examples, the serving NE 1104 may receive the slice information and slice priority information from different entities. For example, the serving NE 1104 may receive the slice information from the core network node 1106 or the previously serving NE 1108 and may further receive the slice priority information from the UE 1102.

At 1120, the serving NE 1104 may select the candidate target cells for a conditional handover or a target cell for a network-initiated handover based on the slice supporting capability information, the slice information, and the slice priority information. For example, the serving NE 1104 may select the candidate target cells for a conditional handover or the target cell for a network-initiated handover that supports an ongoing network slice of the UE 1102 with the highest priority. For a conditional handover, each of the selected candidate cells may support the ongoing network slice with the highest priority, and may further support one or more other ongoing network slices with lower priorities.

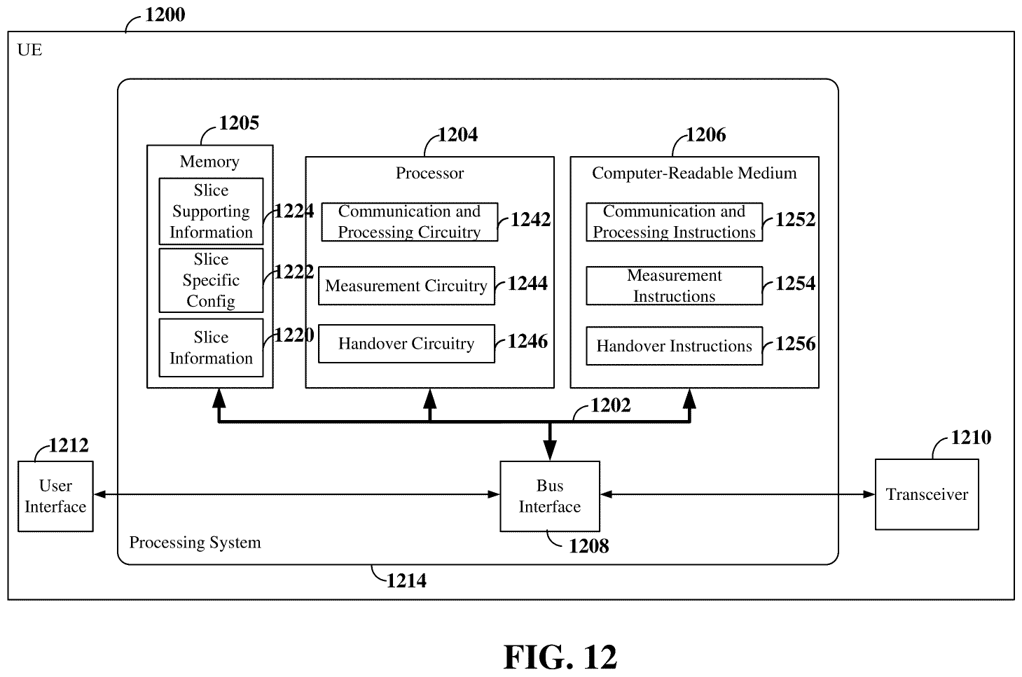

FIG. 12 is a block diagram illustrating an example of a hardware implementation for a user equipment (UE) 1200 employing a processing system 1214. For example, the UE 1200 may correspond to any of the UEs or other scheduled entities shown and described above in reference to FIGS. 1, 2, 4-7, and/or 9-11.

The UE 1200 may be implemented with a processing system 1214 that includes one or more processors 1204. Examples of processors 1204 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1200 may be configured to perform any one or more of the functions described herein. That is, the processor 1204, as utilized in the UE 1200, may be used to implement any one or more of the processes and procedures described below.

The processor 1204 may in some instances be implemented via a baseband or modem chip and in other implementations, the processor 1204 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1214 may be implemented with a bus architecture, represented generally by the bus 1202. The bus 1202 may include any number of interconnecting buses and bridges depending on the specific application of the processing system 1214 and the overall design constraints. The bus 1202 links together various circuits including one or more processors (represented generally by the processor 1204), a memory 1205, and computer-readable media (represented generally by the computer-readable medium 1206). The bus 1202 may also link various other circuits such as timing sources, peripherals, voltage regulators, and power management circuits, which are well known in the art, and therefore, will not be described any further.

A bus interface 1208 provides an interface between the bus 1202 and a transceiver 1210. The transceiver 1210 provides a communication interface or a means for communicating with various other apparatus over a transmission medium (e.g., air interface). Depending upon the nature of the apparatus, a user interface 1212 (e.g., keypad, display, touch screen, speaker, microphone, control knobs, etc.) may also be provided. Of course, such a user interface 1212 is optional, and may be omitted in some examples.

The processor 1204 is responsible for managing the bus 1202 and general processing, including the execution of software stored on the computer-readable medium 1206. The software, when executed by the processor 1204, causes the processing system 1214 to perform the various functions described below for any particular apparatus. The computer-readable medium 1206 and the memory 1205 may also be used for storing data that is manipulated by the processor 1204 when executing software. For example, the memory 1205 may store slice information 1220, a slice specific configuration 1222 (e.g., a slice specific measurement report configuration or a slice specific conditional handover configuration), and/or slice supporting capability information 1224 that may be used by the processor 1204.

One or more processors 1204 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1206.

The computer-readable medium 1206 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1206 may reside in the processing system 1214, external to the processing system 1214, or distributed across multiple entities including the processing system 1214. The computer-readable medium 1206 may be embodied in a computer program product. By way of example, a computer program product may include a computer-readable medium in packaging materials. In some examples, the computer-readable medium 1206 may be part of the memory 1205. Those skilled in the art will recognize how best to implement the described functionality presented throughout this disclosure depending on the particular application and the overall design constraints imposed on the overall system.

In some aspects of the disclosure, the processor 1204 may include circuitry configured for various functions. For example, the processor 1204 may include communication and processing circuitry 1242, configured to communicate with a base station (e.g., gNB or eNB) via a Uu link. In some examples, the communication and processing circuitry 1242 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1242 may include one or more transmit/receive chains.

In some implementations where the communication involves receiving information, the communication and processing circuitry 1242 may obtain information from a component of the UE 1200 (e.g., from the transceiver 1210 that receives the information via radio frequency signaling or some other type of signaling suitable for the applicable communication medium), process (e.g., decode) the information, and output the processed information. For example, the communication and processing circuitry 1242 may output the information to another component of the processor 1204, to the memory 1205, or to the bus interface 1208. In some examples, the communication and processing circuitry 1242 may receive one or more of signals, messages, other information, or any combination thereof. In some examples, the communication and processing circuitry 1242 may receive information via one or more channels. In some examples, the communication and processing circuitry 1242 may include functionality for a means for receiving. In some examples, the communication and processing circuitry 1242 may include functionality for a means for processing, including a means for demodulating, a means for decoding, etc.

In some implementations where the communication involves sending (e.g., transmitting) information, the communication and processing circuitry 1242 may obtain information (e.g., from another component of the processor 1204, the memory 1205, or the bus interface 1208), process (e.g., modulate, encode, etc.) the information, and output the processed information. For example, the communication and processing circuitry 1242 may output the information to the transceiver 1210 (e.g., that transmits the information via radio frequency signaling or some other type of signaling suitable for the applicable communication medium). In some examples, the communication and processing circuitry 1242 may send one or more of signals, messages, other information, or any combination thereof. In some examples, the communication and processing circuitry 1242 may send information via one or more channels. In some examples, the communication and processing circuitry 1242 may include functionality for a means for sending (e.g., a means for transmitting). In some examples, the communication and processing circuitry 1242 may include functionality for a means for generating, including a means for modulating, a means for encoding, etc.

In some examples, the communication and processing circuitry 1242 may be configured to receive from a network entity (e.g., an aggregated or disaggregated base station) a measurement report configuration including at least one slice specific parameter. Each slice specific parameter may be associated with a respective set of one or more network slices of the UE (e.g., ongoing network slices of the UE). The communication and processing circuitry 1242 may further be configured to store the measurement configuration as a slice specific configuration 1222 within the memory 1205. The communication and processing circuitry 1242 may further be configured to transmit a measurement report to the network entity based on the measurement report configuration. The measurement report may include, for example, at least one respective signal quality measurement of at least one of a serving cell or at least one neighbor cell. The communication and processing circuitry 1242 may further be configured to receive slice supporting capability information 1224 indicating respective network slices supported by each of a plurality of neighbor cells and to store the slice supporting capability information 1224 within, for example, memory 1205.

In some examples, the communication and processing circuitry 1242 may be configured to receive a slice specific conditional handover configuration from a network entity. The slice specific handover configuration may be associated with at least one network slice. The communication and processing circuitry 1242 may further be configured to store the slice specific conditional handover configuration as a slice specific configuration 1222 within the memory 1205.

In some examples, the communication and processing circuitry 1242 may further be configured to receive the slice supporting capability information 1224 and a measurement report configuration from the network entity. The communication and processing circuitry 1242 may further be configured to transmit a measurement report based on the measurement report configuration and that includes slice specific information to the network entity. The communication and processing circuitry 1242 may further be configured to execute communication and processing instructions (software) 1252 stored in the computer-readable medium 1206 to implement one or more of the functions described herein.

The processor 1204 may further include measurement circuitry 1244, configured to obtain at least one respective measurement of at least one of the serving cell or one or more neighbor cells based on the measurement report configuration. The measurement circuitry 1244 may further be configured to generate and transmit a measurement report including the at least one respective measurement of at least one of the serving cell or at least one neighbor cell.

In some examples, the measurement report configuration is a slice specific configuration 1222 that includes at least one slice specific parameter, in which each slice specific parameter is associated with a respective set of one or more network slices. In some examples, the at least one neighbor cell supports the respective set of one or more network slices. In other examples, the at least one neighbor cell includes each of a plurality of neighbor cells that are either supportive of or unsupportive of the set of one or more network slices.

In some examples, the measurement report configuration 1222 includes at least one slice specific parameter for a periodic measurement report. In this example, the at least one slice specific parameter included in the measurement report configuration 1222 can include a report interval of the periodic measurement report or a report amount indicating a number of signal quality measurements to be included in the periodic measurement report.

In other examples, the measurement report configuration 1222 includes at least one slice specific parameter for an event-triggered measurement report. In this example, the at least one slice specific parameter is associated with at least one event.

In some examples, the measurement report configuration 1222 includes a common parameter. In this example, the measurement circuitry 1244 may be configured to transmit an additional measurement report based on the common parameter. The additional measurement report may include additional signal quality measurements of other neighbor cells that are unsupportive of the set of one or more network slices. In some examples, a slice specific parameter of the at least one slice specific parameter may include an offset of the common parameter.

In some examples, the measurement report may include slice specific assistance information including at least one respective measurement of at least one neighbor cell supporting at least one network slice of the UE. In some examples, the respective measurement of the at least one neighbor cell is higher than corresponding measurements of other neighbor cells supporting the at least one network slice. In some examples, the at least one neighbor cell includes each of a plurality of neighbor cells supporting the at least one network slice. In some examples, the measurement report configuration may further request the measurement circuitry 1244 to report a highest measurement associated with a best cell of the at least one neighbor cell supporting the at least one network slice in the measurement report.

In some examples, the slice supporting assistance information in the measurement report may include slice information and/or slice priority information. For example, the slice supporting assistance information may include a slice ID or slice group ID, a bearer ID, or a PDU session ID for each of the at least one network slice. As another example, the slice priority information may indicate a respective priority associated with each of the at least one network slice. In some examples, the slice information and/or slice priority information may be sent by the communication and processing circuitry 1242 to the serving network entity in a separate message (e.g., a UEAssistanceInformation message or other RRC message). The measurement circuitry 1244 may further be configured to execute measurement instructions (software) 1254 stored in the computer-readable medium 1206 to implement one or more of the functions described herein.

The processor 1204 may further include handover circuitry 1246, configured to perform a handover of the UE 1200 from a source network entity to a target network entity. In some examples, the handover circuitry 1246 may be configured to perform a conditional handover based on a slice specific conditional handover configuration 1222. In some examples, the slice specific conditional handover configuration 1222 includes at least one candidate target cell that supports at least one network slice of the UE. In some examples, the slice specific handover configuration 1222 includes a slice specific execution condition for executing a handover to a target cell. In some examples, the slice specific conditional handover configuration further includes slice information. The slice information may include, for example, a slide identifier (ID), a bearer ID, or a protocol data unit (PDU) session ID. In some examples, the at least one network slice includes a slice group including a plurality of network slices.

In some examples, the handover circuitry 1246 may be configured to perform a respective conditional handover evaluation for each of the at least one network slice based on the slice specific conditional handover configuration. The handover circuitry 1246 may further be configured to perform a conditional handover of the at least one network slice based on the conditional handover evaluation(s) for each of the at least one network slice.

In some examples, the communication and processing circuitry 1242 may be configured to receive a plurality of slice specific conditional handover configurations including the slice specific conditional handover configuration. Each slice specific conditional handover configuration may be associated with a respective set of one or more network slices. Each set of one or more network slices may have a respective priority associated therewith. In this example, the handover circuitry 1246 may be configured to perform a respective conditional handover evaluation for each of the respective sets of one or more network slices using corresponding ones of the plurality of slice specific conditional handover configurations based on the respective priority of each of the respective sets of one or more network slices. In addition, the handover circuitry 1246 may further be configured to perform a conditional handover of at least a set of one or more network slices having a highest priority for which a triggering condition of the respective conditional handover evaluation is met to a candidate cell supporting the set of one or more network slices.

In other examples, the communication and processing circuitry 1242 may be configured to receive a plurality of slice specific conditional handover configurations including the slice specific conditional handover configuration. Each slice specific conditional handover configuration may be associated with a respective set of one or more network slices. In addition, the communication and processing circuitry 1242 may be configured to receive an order of the plurality of slice specific conditional handover configurations. In this example, the handover circuitry 1246 may be configured to perform a respective conditional handover evaluation for one or more of the respective sets of one or more network slices using corresponding ones of the plurality of slice specific conditional handover configurations based on the order. In addition, the handover circuitry 1246 may further be configured to perform a conditional handover of at least a set of one or more network slices having a highest priority for which a triggering condition of the respective conditional handover evaluation is met to a candidate cell supporting the set of one or more network slices.

In some examples, the communication and processing circuitry 1242 may be configured to receive a handover command from a serving network entity instructing the handover circuitry 1246 to perform a handover to a target network entity (e.g., target neighbor cell) selected by the serving network entity based on slice specific assistance information. The handover circuitry 1246 may then further be configured to perform the handover based on the handover command. The handover circuitry 1246 may further be configured to execute handover instructions (software) 1256 stored in the computer-readable medium 1206 to implement one or more of the functions described herein.

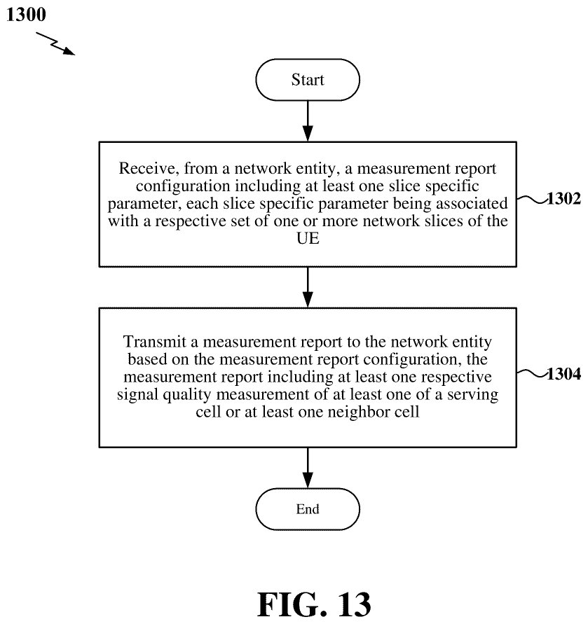

FIG. 13 is a flow chart illustrating an exemplary method 1300 of facilitating slice aware mobility at a UE in accordance with some aspects of the present disclosure. As described below, some or all illustrated features may be omitted in a particular implementation within the scope of the present disclosure, and some illustrated features may not be required for implementation of all examples. In some examples, the process 1300 may be carried out by the UE 1200 illustrated in FIG. 12. In some examples, the process 1300 may be carried out by any suitable apparatus or means for carrying out the functions or algorithm described below.

At block 1302, the UE may receive, from a network entity, a measurement report configuration including at least one slice specific parameter, each slice specific parameter being associated with a respective set of one or more network slices of the UE. In some examples, the UE may further be configured to receive slice supporting capability information indicating respective network slices supported by each of a plurality of neighbor cells. For example, the communication and processing circuitry 1242 and transceiver 1210 shown and described above in connected with FIG. 12 may provide a means to receive the measurement report configuration.

At block 1304, the UE may transmit a measurement report to the network entity based on the measurement report configuration, the measurement report including at least one respective signal quality measurement of at least one of a serving cell or at least one neighbor cell. In some examples, the measurement report includes a periodic measurement report and the at least one slice specific parameter includes at least one of a report interval of the periodic measurement report or a report amount indicating a number of signal quality measurements to be included in the periodic measurement report. In some examples, the measurement report is an event-triggered measurement report and the at least one slice specific parameter is associated with at least one event. In some examples, the at least one neighbor cell supports the respective set of one or more network slices.

In some examples, the measurement report configuration further includes a common parameter. In this example, the UE may further transmit an additional measurement report based on the common parameter, the additional measurement report including additional signal quality measurements of other neighbor cells unsupportive of the set of one or more network slices. In some examples, a slice specific parameter of the at least one slice specific parameter comprises an offset of the common parameter.

In some examples, the at least one neighbor cell includes each of a plurality of neighbor cells that are either supportive of or unsupportive of the set of one or more network slices. For example, the measurement circuitry 1244, together with the communication and processing circuitry 1242 and the transceiver 1210, shown and described above in connection with FIG. 12 may provide a means to transmit the measurement report.

In one configuration, a UE configured for wireless communication includes means for receiving, from a network entity, a measurement report configuration including at least one slice specific parameter, each slice specific parameter being associated with a respective set of one or more network slices of the UE, and means for transmitting a measurement report to the network entity based on the measurement report configuration, the measurement report including at least one respective signal quality measurement of at least one of a serving cell or at least one neighbor cell. In one aspect, the aforementioned means may be the processor 1204 shown in FIG. 12 configured to perform the functions recited by the aforementioned means. In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1, 2, 4-7 and/or 9-12, and utilizing, for example, the processes and/or algorithms described herein in relation to FIG. 13.

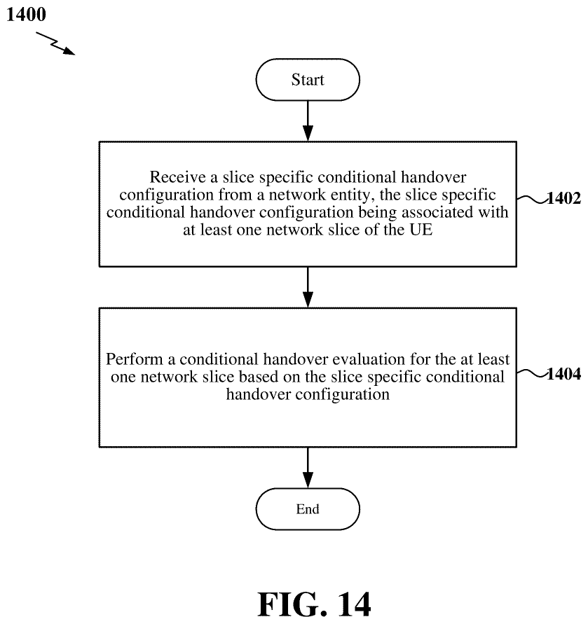

FIG. 14 is a flow chart illustrating another exemplary method 1400 of facilitating slice aware mobility at a UE in accordance with some aspects of the present disclosure. As described below, some or all illustrated features may be omitted in a particular implementation within the scope of the present disclosure, and some illustrated features may not be required for implementation of all examples. In some examples, the process 1400 may be carried out by the UE 1200 illustrated in FIG. 12. In some examples, the process 1400 may be carried out by any suitable apparatus or means for carrying out the functions or algorithm described below.

At block 1402, the UE may receive a slice specific conditional handover configuration from a network entity, the slice specific conditional handover configuration being associated with at least one network slice of the UE. In some examples, the slice specific conditional handover configuration includes at least one candidate target cell that supports the at least one network slice. In some examples, the slice specific conditional handover configuration includes a slice specific execution condition for executing a handover to a target cell. In some examples, the slice specific conditional handover configuration includes slice information, the slice information including a slice identifier (ID), a bearer ID, or a protocol data unit (PDU) session ID. In some examples, the at least one network slice includes a slice group including a plurality of network slices. For example, the communication and processing circuitry 1242 and transceiver 1210 shown and described above in connected with FIG. 12 may provide a means to receive the slice specific handover configuration.

At block 1404, the UE may perform a conditional handover evaluation for the at least one network slice based on the slice specific conditional handover configuration. In some examples, the UE may receive a plurality of slice specific conditional handover configurations including the slice specific conditional handover configuration, each slice specific conditional handover configuration being associated with a respective set of one or more network slices, each set of one or more network slices having a respective priority associated therewith. In this example, the UE may perform a respective conditional handover evaluation for each of the respective sets of one or more network slices using corresponding ones of the plurality of slice specific conditional handover configurations based on the respective priority of each of the respective sets of one or more network slices. In addition, the UE may perform a conditional handover of at least a set of one or more network slices having a highest priority for which a triggering condition of the respective conditional handover evaluation is met to a candidate cell supporting the set of one or more network slices.

In some examples, the UE may receive a plurality of slice specific conditional handover configurations including the slice specific conditional handover configuration, each slice specific conditional handover configuration being associated with a respective set of one or more network slices. In addition, the UE may receive an order of the plurality of slice specific conditional handover configurations. In this example, the UE may perform a respective conditional handover evaluation for one or more of the respective sets of one or more network slices using corresponding ones of the plurality of slice specific conditional handover configurations based on the order. For example, the handover circuitry 1246, together with the communication and processing circuitry 1242 and transceiver 1210, shown and described above in connection with FIG. 12 may provide a means to perform a conditional handover evaluation for the at least one network slice based on the slice specific conditional handover configuration.

In one configuration, a UE 1200 configured for wireless communication includes means for receiving a slice specific conditional handover configuration from a network entity, the slice specific conditional handover configuration being associated with at least one network slice of the UE, and means performing a conditional handover evaluation for the at least one network slice based on the slice specific conditional handover configuration. In one aspect, the aforementioned means may be the processor 1204 shown in FIG. 12 configured to perform the functions recited by the aforementioned means. In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1, 2, 4-7 and/or 9-12, and utilizing, for example, the processes and/or algorithms described herein in relation to FIG. 14.

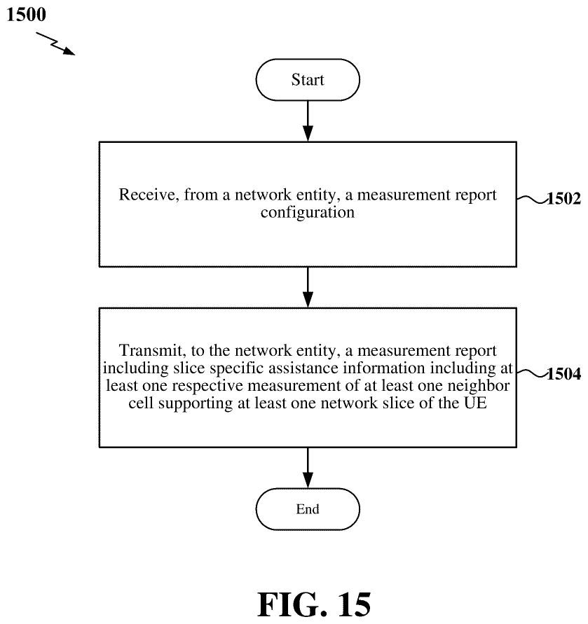

FIG. 15 is a flow chart illustrating another exemplary method 1500 of facilitating slice aware mobility at a UE in accordance with some aspects of the present disclosure. As described below, some or all illustrated features may be omitted in a particular implementation within the scope of the present disclosure, and some illustrated features may not be required for implementation of all examples. In some examples, the process 1500 may be carried out by the UE 1200 illustrated in FIG. 12. In some examples, the process 1500 may be carried out by any suitable apparatus or means for carrying out the functions or algorithm described below.

At block 1502, the UE may receive, from a network entity, a measurement report configuration. In some examples, the measurement report configuration may request the UE to report a highest measurement associated with a best cell of at least one neighbor cell supporting at least one network slice of the UE in the measurement report. For example, the communication and processing circuitry 1242 and transceiver 1210 shown and described above in connected with FIG. 12 may provide a means to receive the measurement report configuration.

At 1504, the UE may transmit, to the network entity, a measurement report including slice specific assistance information including at least one respective measurement of at least one neighbor cell supporting at least one network slice of the UE. In some examples, the respective measurement of the at least one neighbor cell is higher than corresponding measurements of other neighbor cells supporting the at least one network slice. In some examples, the at least one neighbor cell includes each of a plurality of neighbor cells supporting the at least one network slice.

In some examples, the slice supporting assistance information in the measurement report may include slice information and/or slice priority information. For example, the slice supporting assistance information may include a slice ID or slice group ID, a bearer ID, or a PDU session ID for each of the at least one network slice. As another example, the slice priority information may indicate a respective priority associated with each of the at least one network slice. In some examples, the slice information and/or slice priority information may be sent to the network entity in a separate message (e.g., a UEAssistanceInformation message or other RRC message). For example, the measurement circuitry 1244, together with the communication and processing circuitry 1242 and transceiver 1210, shown and described above in connection with FIG. 12 may provide a means to transmit the measurement report including the slice specific assistance information.

In one configuration, a UE 1200 configured for wireless communication includes means for receiving, from a network entity, a measurement report configuration, and means for transmit, to the network entity, a measurement report including slice specific assistance information including at least one respective measurement of at least one neighbor cell supporting at least one network slice of the UE. In one aspect, the aforementioned means may be the processor 1204 shown in FIG. 12 configured to perform the functions recited by the aforementioned means. In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1, 2, 4-7 and/or 9-12, and utilizing, for example, the processes and/or algorithms described herein in relation to FIG. 15.

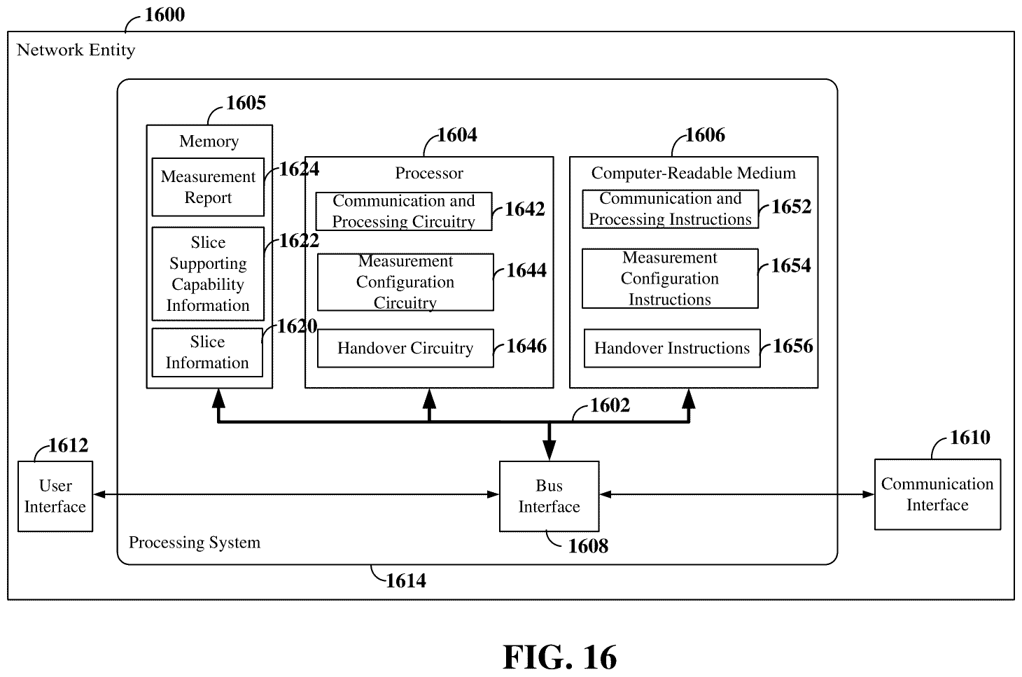

FIG. 16 is a block diagram illustrating an example of a hardware implementation of a network entity 1600 employing a processing system 1614 according to some aspects. The network entity 1600 may be, for example, any base station (e.g., gNB, eNB) or other scheduling entity as illustrated in any one or more of FIGS. 1, 2, 4-7 and/or 9-11. The network entity 1600 may further be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In addition, the network entity 1600 may be a stationary network entity or a mobile network entity.

In accordance with various aspects of the disclosure, an element, or any portion of an element, or any combination of elements may be implemented with a processing system 1614 that includes one or more processors, such as processor 1604. The processing system 1614 may be substantially the same as the processing system 1314 as shown and described above in connection with FIG. 13, including a bus interface 1608, a bus 1602, a memory 1605, a processor 1604, and a computer-readable medium 1606. Accordingly, their descriptions will not be repeated for the sake of brevity. Furthermore, the network entity 1600 may include an optional user interface 1612 and a communication interface 1610. The communication interface 1610 may provide an interface (e.g., wireless or wired) between the network entity 1600 and a plurality of transmission and reception points (TRPs), a core network node, and/or a plurality of UEs. In some examples, the communication interface 1610 may include a wireless transceiver.

The processor 1604, as utilized in the network entity 1600, may be used to implement any one or more of the processes described below. In some examples, the memory 1605 may store slice information 1620, slice supporting capability information 1622, and/or a measurement report 1624 that may be used by the processor 1604.

In some aspects of the disclosure, the processor 1604 may include communication and processing circuitry 1642 configured for various functions, including, for example, communicating with one or more UEs or other scheduled entities, or a core network node. In some examples, the communication and processing circuitry 1642 may communicate with one or more UEs via one or more TRPs associated with the network entity 1600. In some examples, the communication and processing circuitry 1642 may include one or more hardware components that provide the physical structure that performs processes related to wireless communication (e.g., signal reception and/or signal transmission) and signal processing (e.g., processing a received signal and/or processing a signal for transmission). In addition, the communication and processing circuitry 1642 may be configured to process and transmit downlink traffic and downlink control and receive and process uplink traffic and uplink control.

In some examples, the communication and processing circuitry 1642 may be configured to transmit, to a UE, a measurement report configuration including at least one slice specific parameter. Each slice specific parameter can be associated with a respective set of one or more network slices of the UE. The communication and processing circuitry 1642 may further be configured to receive, from the UE, a measurement report 1624 based on the measurement report configuration. In some examples, the measurement report can include at least one respective signal quality measurement of at least one of a serving cell or at least one neighbor cell. In some examples, the at least one neighbor cell supports the respective set of one or more network slices. In other examples, the at least one neighbor cell includes each of a plurality of neighbor cells that are either supportive of or unsupportive of the set of one or more network slices. In other examples, the measurement report 1624 can include slice specific assistance information. The slice specific assistance information can include a respective measurement for at least one neighbor cell of a plurality of neighbor cells that supports at least one network slice of the UE. In some examples, the measurement report may include a highest measurement associated with a best neighbor cell of the at least one neighbor cell. The communication and processing circuitry 1642 may further be configured to store the measurement report 1624 within, for example, memory 1605.

In some examples, the communication and processing circuitry 1642 may further be configured to receive slice information 1620 identifying at least one network slice configured for a user equipment (UE) and supported by a serving cell of the UE. The communication and processing circuitry 1642 may further be configured to receive slice supporting capability information 1622 indicating respective network slices supported by each of a plurality of neighbor cells of the serving cell. The communication and processing circuitry 1642 may further be configured to store the slice information 1620 and slice supporting capability information 1622 within, for example, memory 1605. The communication and processing circuitry 1642 may further be configured to transmit, to the UE, the slice supporting capability information 1622.

In some examples, the communication and processing circuitry 1642 may further be configured to transmit a slice specific conditional handover configuration to the UE including at least one candidate target cell. In other examples, the communication and processing circuitry 1642 may be configured to transmit a measurement report configuration requesting the UE to report the highest measurement in the measurement report 1624.

In some examples, the communication and processing circuitry 1642 may further be configured to receive a message including the respective priority of each of a plurality of network slices. The communication and processing circuitry 1642 may further be configured to execute communication and processing instructions (software) 1652 stored on the computer-readable medium 1606 to implement one or more functions described herein.

The processor 1604 may further include measurement configuration circuitry 1644 configured to generate the measurement report configuration for the UE. In examples in which the measurement report is a periodic measurement report, the measurement configuration circuitry 1644 may be configured to generate the measurement report configuration including the at least one slice specific parameter, where the at least one slice specific parameter includes at least one of a report interval of the periodic measurement report or a report amount indicating a number of signal quality measurements to be included in the periodic measurement report. In examples in which the measurement report is an event-triggered measurement report, the measurement configuration circuitry 1644 may be configured to generate the measurement report configuration including the at least one slice specific parameter, where the at least one slice specific parameter is associated with at least one event.

In some examples, the measurement configuration circuitry 1644 may further be configured to generate the measurement report including a common parameter. In this example, the communication and processing circuitry 1642 may further be configured to receive an additional measurement report based on the common parameter. The additional measurement report can include additional signal quality measurements of other neighbor cells unsupportive of the set of one or more network slices. In some examples, the measurement configuration circuitry 1644 may be configured to generate a slice specific parameter of the at least one slice specific parameter to include an offset of the common parameter.

In some examples, the measurement configuration circuitry 1644 may be configured to generate a measurement report configuration requesting the UE to report the highest measurement associated with a best neighbor cell that supports the at least one network slice in the measurement report. The measurement configuration circuitry 1644 may further be configured to execute measurement configuration instructions (software) 1654 stored on the computer-readable medium 1606 to implement one or more functions described herein.

The processor 1604 may further include handover circuitry 1646 configured to manage a handover of the UE. In some examples, the handover circuitry 1646 may be configured to identify at least one candidate target cell of the plurality of neighbor cells for a handover of the at least one network slice based on the slice information and the slice supporting capability information. The at least one candidate target cell can support the at least one network slice. In some examples in which the handover is a conditional handover, the handover circuitry 1646 may be configured to include the at least one candidate target cell supporting the at least one network slice in the slice specific conditional handover configuration. In other examples in which the handover is a conditional handover, the handover circuitry 1646 may be configured to include a slice specific execution condition for executing the handover to a target cell of the at least one target cell in the slice specific conditional handover configuration. In other examples in which the handover is a conditional handover, the handover circuitry 1646 may be configured to include a respective slice specific conditional handover configuration for each of the at least one network slice and a respective priority of each of the respective slice specific conditional handover configuration.

In examples in which the measurement report includes slice specific information, the at least one network slice may include a plurality of network slices and the measurement report may further include a respective priority associated with each of the plurality of network slices. In this example, the handover circuitry 1646 may be configured to identify the at least one candidate target cell further based on the respective priority of each of the plurality of network slices.

In examples in which the handover is a network-initiated handover, the at least one network slice includes a plurality of network slices, each having a respective priority associated therewith. In this example, the handover circuitry 1646 may be configured to identify the at least one candidate target cell further based on the respective priority of each of the plurality of network slices. The handover circuitry 1646 may further be configured to execute handover instructions (software) 1656 stored on the computer-readable medium 1606 to implement one or more of the functions described herein.

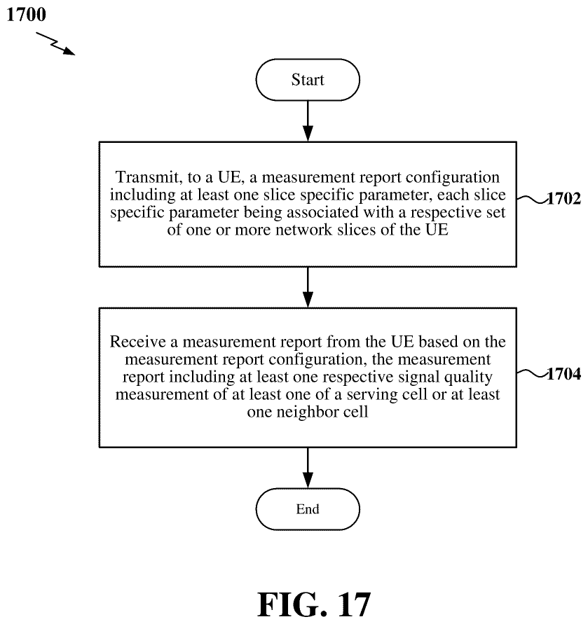

FIG. 17 is a flow chart illustrating an exemplary method 1700 of facilitating slice aware mobility at a network entity according to some aspects. As described below, some or all illustrated features may be omitted in a particular implementation within the scope of the present disclosure, and some illustrated features may not be required for implementation of all embodiments. In some examples, the process 1700 may be carried out by the network entity 1600 illustrated in FIG. 16. In some examples, the process 1700 may be carried out by any suitable apparatus or means for carrying out the functions or algorithm described below.

At block 1702, the network entity may transmit, to a UE, a measurement report configuration including at least one slice specific parameter, each slice specific parameter being associated with a respective set of one or more network slices of the UE. For example, the measurement configuration circuitry 1644, together with the communication and processing circuitry 1642 and communication interface 1610, shown and described above in connection with FIG. 16 may provide a means to transmit the measurement report configuration.

At block 1704, the network entity may receive a measurement report from the UE based on the measurement report configuration, the measurement report including at least one respective signal quality measurement of at least one of a serving cell or at least one neighbor cell. In some examples, the measurement report is a periodic measurement report and the at least one slice specific parameter includes at least one of a report interval of the periodic measurement report or a report amount indicating a number of signal quality measurements to be included in the periodic measurement report. In some examples, the measurement report is an event-triggered measurement report and the at least one slice specific parameter is associated with at least one event.

In some examples, the at least one neighbor cell supports the respective set of one or more network slices. In some examples, the at least one neighbor cell includes each of a plurality of neighbor cells that are either supportive of or unsupportive of the set of one or more network slices. In some examples, the network entity may receive slice supporting capability information indicating respective network slices supported by each of a plurality of neighbor cells including the at least one neighbor cell.

In some examples, the measurement report configuration includes a common parameter and the network entity further receives an additional measurement report based on the common parameter. The additional measurement report can include additional signal quality measurements of other neighbor cells unsupportive of the set of one or more network slices. In some examples, a slice specific parameter of the at least one slice specific parameter comprises an offset of the common parameter. For example, the communication and processing circuitry 1642, together with the communication interface 1610, shown and described above in connection with FIG. 16 may provide a means to receive the measurement report from the UE based on the measurement report configuration.

In one configuration, the network entity includes means for transmitting, to a UE, a measurement report configuration including at least one slice specific parameter, each slice specific parameter being associated with a respective set of one or more network slices of the UE, and means for receiving a measurement report from the UE based on the measurement report configuration, the measurement report including at least one respective signal quality measurement of at least one of a serving cell or at least one neighbor cell. In one aspect, the aforementioned means may be the processor 1604 shown in FIG. 16 configured to perform the functions recited by the aforementioned means. In another aspect, the aforementioned means may be a circuit or any apparatus configured to perform the functions recited by the aforementioned means.

Of course, in the above examples, the circuitry included in the processor 1604 is merely provided as an example, and other means for carrying out the described functions may be included within various aspects of the present disclosure, including but not limited to the instructions stored in the computer-readable storage medium 1606, or any other suitable apparatus or means described in any one of FIGS. 1, 2, 4-7, 9-11, and/or 16 and utilizing, for example, the processes and/or algorithms described herein in relation to FIG. 17.

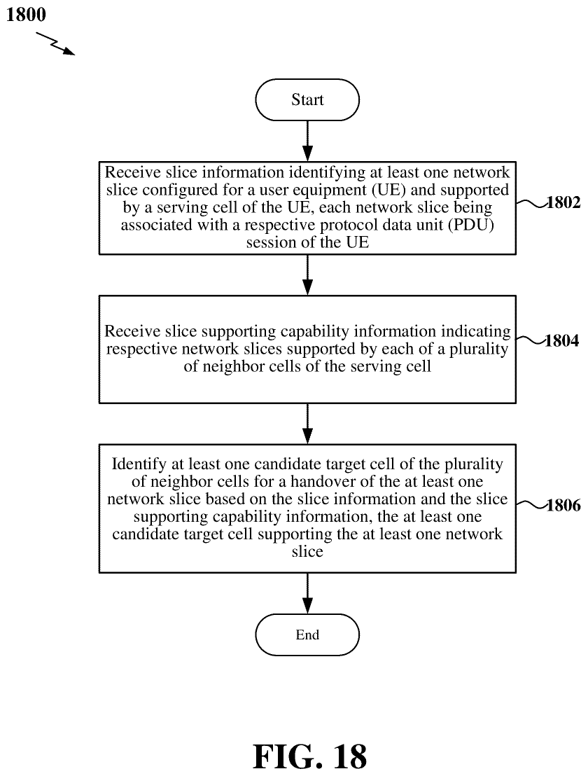

FIG. 18 is a flow chart illustrating an exemplary method 1800 of facilitating slice aware mobility at a network entity according to some aspects. As described below, some or all illustrated features may be omitted in a particular implementation within the scope of the present disclosure, and some illustrated features may not be required for implementation of all embodiments. In some examples, the process 1800 may be carried out by the network entity 1600 illustrated in FIG. 16. In some examples, the process 1800 may be carried out by any suitable apparatus or means for carrying out the functions or algorithm described below.

At block 1802, the network entity may receive slice information identifying at least one network slice configured for a user equipment (UE) and supported by a serving cell of the UE, each network slice being associated with a respective protocol data unit (PDU) session of the UE. For example, the communication and processing circuitry 1642, together with the communication interface 1610, shown and described above in connection with FIG. 16 may provide a means to receive the slice information.

At block 1804, the network entity may receive slice supporting capability information indicating respective network slices supported by each of a plurality of neighbor cells of the serving cell. In some examples, the network entity may further transmit the slice supporting capability information to the UE. For example, the communication and processing circuitry 1642, together with the communication interface 1610, shown and described above in connection with FIG. 16 may provide a means to receive the slice supporting capability information.

At block 1806, the network entity may identify at least one candidate target cell of the plurality of neighbor cells for a handover of the at least one network slice based on the slice information and the slice supporting capability information, the at least one candidate target cell supporting the at least one network slice. In some examples, the network entity may further transmit a slice specific conditional handover configuration to the UE including the at least one candidate target cell. In some examples, the slice specific conditional handover configuration further includes a slice specific execution condition for executing a handover to a target cell of the at least one candidate target cell. In some examples, the slice specific conditional handover configuration further includes a respective slice specific conditional handover configuration for each of the at least one network slice and a respective priority of each of the respective slice specific conditional handover configuration.

In some examples, the network entity may further receive a measurement report including slice specific assistance information, the slice specific assistance information including a respective measurement for at least one neighbor cell of the plurality of neighbor cells that supports the at least one network slice. In some examples, the measurement report includes a highest measurement associated with a best neighbor cell of the at least one neighbor cell. In some examples, the network entity may further transmit a measurement report configuration requesting the UE to report the highest measurement in the measurement report.

In some examples, the at least one network slice includes a plurality of network slices and the measurement report further includes a respective priority associated with each of the plurality of network slices. In this example, the network entity may identify the at least one candidate target cell further based on the respective priority of each of the plurality of network slices. In some examples, the at least one network slice includes a plurality of network slices, each having a respective priority associated therewith. In this example, the network entity may identify the at least one candidate target cell further based on the respective priority of each of the plurality of network slices. In some examples, the network entity may further receive a message including the respective priority of each of the plurality of network slices. For example, the handover circuitry 1646, together with the communication and processing circuitry 1642 and communication interface 1610, shown and described above in connection with FIG. 16 may provide a means to identify the at least one candidate target cell.

In one configuration, the network entity includes means for receiving slice information identifying at least one network slice configured for a user equipment (UE) and supported by a serving cell of the UE, means for receiving slice supporting capability information indicating respective network slices supported by each of a plurality of neighbor cells of the serving cell, and means for identifying at least one candidate target cell of the plurality of neighbor cells for a handover of the at least one network slice based on the slice information and the slice supporting capability information, the at least one candidate target cell supporting the at least one network slice. In one aspect, the aforementioned means may be the processor 1604 shown in FIG. 16 configured to perform the functions recited by the aforementioned means. In another aspect, the aforementioned means may be a circuit or any apparatus configured to perform the functions recited by the aforementioned means.

Of course, in the above examples, the circuitry included in the processor 1604 is merely provided as an example, and other means for carrying out the described functions may be included within various aspects of the present disclosure, including but not limited to the instructions stored in the computer-readable storage medium 1606, or any other suitable apparatus or means described in any one of FIGS. 1, 2, 4-7, 9-11, and/or 16 and utilizing, for example, the processes and/or algorithms described herein in relation to FIG. 17.

The processes shown in FIGS. 13-15, 17, and 18 may include additional aspects, such as any single aspect or any combination of aspects described below and/or in connection with one or more other processes described elsewhere herein.

Aspect 1: A method for wireless communication at a user equipment (UE), the method comprising: receiving, from a network entity, a measurement report configuration comprising at least one slice specific parameter, each slice specific parameter being associated with a respective set of one or more network slices of the UE; and transmitting a measurement report to the network entity based on the measurement report configuration, the measurement report comprising at least one respective signal quality measurement of at least one of a serving cell or at least one neighbor cell.

Aspect 2: The method of aspect 1, wherein the measurement report comprises a periodic measurement report and the at least one slice specific parameter comprises at least one of a report interval of the periodic measurement report or a report amount indicating a number of signal quality measurements to be included in the periodic measurement report.

Aspect 3: The method of aspect 1, wherein the measurement report is an event-triggered measurement report and the at least one slice specific parameter is associated with at least one event.

Aspect 4: The method of any of aspects 1 through 3, wherein the at least one neighbor cell supports the respective set of one or more network slices.

Aspect 5: The method of any of aspects 1 through 4, wherein the measurement report configuration further comprises a common parameter, and further comprising: transmitting an additional measurement report based on the common parameter, wherein the additional measurement report comprises additional signal quality measurements of other neighbor cells unsupportive of the set of one or more network slices.

Aspect 6: The method of aspect 5, wherein a slice specific parameter of the at least one slice specific parameter comprises an offset of the common parameter.

Aspect 7: The method of any of aspects 1 through 3, wherein the at least one neighbor cell comprises each of a plurality of neighbor cells that are either supportive of or unsupportive of the set of one or more network slices.

Aspect 8: The method of any of aspects 1 through 7, further comprising: receiving slice supporting capability information indicating respective network slices supported by each of a plurality of neighbor cells including the at least one neighbor cell.

Aspect 9: A method of wireless communication at a user equipment (UE), the method comprising: receiving a slice specific conditional handover configuration from a network entity, the slice specific conditional handover configuration being associated with at least one network slice of the UE; and performing a conditional handover evaluation for the at least one network slice based on the slice specific conditional handover configuration.

Aspect 10: The method of aspect 9, wherein the slice specific conditional handover configuration comprises at least one candidate target cell that supports the at least one network slice.

Aspect 11: The method of aspect 9 or 10, wherein the slice specific conditional handover configuration comprises a slice specific execution condition for executing a handover to a target cell.

Aspect 12: The method of any of aspects 9 through 11, wherein the slice specific conditional handover configuration comprises slice information, the slice information comprising a slice identifier (ID), a bearer ID, or a protocol data unit (PDU) session ID.

Aspect 13: The method of any of aspects 9 through 12, wherein the receiving the slice specific conditional handover configuration comprises: receiving a plurality of slice specific conditional handover configurations including the slice specific conditional handover configuration, each slice specific conditional handover configuration being associated with a respective set of one or more network slices, each set of one or more network slices having a respective priority associated therewith, and wherein the performing the conditional handover evaluation further comprises: performing a respective conditional handover evaluation for each of the respective sets of one or more network slices using corresponding ones of the plurality of slice specific conditional handover configurations based on the respective priority of each of the respective sets of one or more network slices.

Aspect 14: The method of aspect 13, further comprising: performing a conditional handover of at least a set of one or more network slices having a highest priority for which a triggering condition of the respective conditional handover evaluation is met to a candidate cell supporting the set of one or more network slices.

Aspect 15: The method of any of aspects 9 through 14, wherein the at least one network slice comprises a slice group including a plurality of network slices.

Aspect 16: The method of any of aspects 9 through 12 or 15, wherein the receiving the slice specific conditional handover configuration comprises: receiving a plurality of slice specific conditional handover configurations including the slice specific conditional handover configuration, each slice specific conditional handover configuration being associated with a respective set of one or more network slices; and receiving an order of the plurality of slice specific conditional handover configurations, and wherein the performing the conditional handover evaluation further comprises: performing a respective conditional handover evaluation for one or more of the respective sets of one or more network slices using corresponding ones of the plurality of slice specific conditional handover configurations based on the order.

Aspect 17: A user equipment (UE) comprising a transceiver, a memory, and a processor coupled to the transceiver and the memory, the processor configured to perform a method of any one of aspects 1 through 8 or 9 through 16.

Aspect 18: A user equipment (UE) comprising means for performing a method of any one of aspects 1 through 8 or 9 through 16.

Aspect 19: A non-transitory computer-readable medium having stored therein instructions executable by one or more processors of a user equipment (UE) to perform a method of any one of aspects 1 through 8 or 9 through 16.

Aspect 20: A method operable at a network entity, the method comprising: receiving slice information identifying at least one network slice configured for a user equipment (UE) and supported by a serving cell of the UE; receiving slice supporting capability information indicating respective network slices supported by each of a plurality of neighbor cells of the serving cell; and identifying at least one candidate target cell of the plurality of neighbor cells for a handover of the at least one network slice based on the slice information and the slice supporting capability information, the at least one candidate target cell supporting the at least one network slice.

Aspect 21: The method of aspect 20, further comprising: transmitting a slice specific conditional handover configuration to the UE comprising the at least one candidate target cell.

Aspect 22: The method of aspect 21, wherein the slice specific conditional handover configuration further comprises a slice specific execution condition for executing a handover to a target cell of the at least one candidate target cell.

Aspect 23: The method of aspect 21, wherein the slice specific conditional handover configuration further comprises a respective slice specific conditional handover configuration for each of the at least one network slice and a respective priority of each of the respective slice specific conditional handover configuration.

Aspect 24: The method of any of aspects 20 through 23, further comprising: receiving a measurement report comprising slice specific assistance information, the slice specific assistance information comprising a respective measurement for at least one neighbor cell of the plurality of neighbor cells that supports the at least one network slice.

Aspect 25: The method of aspect 24, wherein the measurement report comprises a highest measurement associated with a best neighbor cell of the at least one neighbor cell.

Aspect 26: The method of aspect 25, further comprising: transmitting a measurement report configuration requesting the UE to report the highest measurement in the measurement report.

Aspect 27: The method of any of aspects 24 through 26, wherein the at least one network slice comprises a plurality of network slices and the measurement report further comprises a respective priority associated with each of the plurality of network slices, and wherein the identifying at least one candidate target cell further comprises: identifying the at least one candidate target cell further based on the respective priority of each of the plurality of network slices.

Aspect 28: The method of any of aspects 20 through 27, further comprising: transmitting the slice supporting capability information to the UE.

Aspect 29: The method of any of aspects 20 through 22, wherein the at least one network slice comprises a plurality of network slices, each having a respective priority associated therewith, and wherein the identifying at least one candidate target cell further comprises: identifying the at least one candidate target cell further based on the respective priority of each of the plurality of network slices.

Aspect 30: The method of aspect 29, further comprising: receiving a message comprising the respective priority of each of the plurality of network slices.

Aspect 31: A method for wireless communication at a network entity, the method comprising: providing a measurement report configuration for a user equipment (UE), the measurement report configuration comprising at least one slice specific parameter, each slice specific parameter being associated with a respective set of one or more network slices of the UE; and receiving a measurement report based on the measurement report configuration, the measurement report comprising at least one respective signal quality measurement of at least one of a serving cell or at least one neighbor cell.

Aspect 32: The method of aspect 31, wherein the measurement report comprises a periodic measurement report and the at least one slice specific parameter comprises at least one of a report interval of the periodic measurement report or a report amount indicating a number of signal quality measurements to be included in the periodic measurement report.

Aspect 33: The method of aspect 31, wherein the measurement report is an event-triggered measurement report and the at least one slice specific parameter is associated with at least one event.

Aspect 34: A network entity comprising a transceiver, a memory, and a processor coupled to the transceiver and the memory, the processor configured to perform a method of any one of aspects 20 through 30 or 31 through 33.

Aspect 18: A network entity comprising means for performing a method of any one of aspects 20 through 30 or 31 through 33.

Aspect 19: A non-transitory computer-readable medium having stored therein instructions executable by one or more processors of a network entity to perform a method of any one of aspects 20 through 30 or 31 through 33.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “obtaining” may include one or more actions including, but not limited to, receiving, generating, determining, or any combination thereof.

One or more of the components, steps, features and/or functions illustrated in FIGS. 1-18 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 4-7, and/or 9-12 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE), comprising:
a transceiver;
a memory; and
a processor coupled to the transceiver and the memory, the processor being configured to:
receive, from a network entity and via the transceiver, a measurement report configuration comprising at least one slice specific parameter, each slice specific parameter being associated with a respective set of one or more network slices of the UE; and
transmit a measurement report to the network entity based on the measurement report configuration via the transceiver, the measurement report comprising at least one respective signal quality measurement of at least one of a serving cell or at least one neighbor cell.

2. The UE of claim 1, wherein the measurement report comprises a periodic measurement report and the at least one slice specific parameter comprises at least one of a report interval of the periodic measurement report or a report amount indicating a number of signal quality measurements to be included in the periodic measurement report.

3. The UE of claim 1, wherein the measurement report is an event-triggered measurement report and the at least one slice specific parameter is associated with at least one event.

4. The UE of claim 1, wherein the at least one neighbor cell supports the respective set of one or more network slices.

5. The UE of claim 1, wherein the measurement report configuration further comprises a common parameter, and wherein the processor is further configured to:
transmit an additional measurement report based on the common parameter, wherein the additional measurement report comprises additional signal quality measurements of other neighbor cells unsupportive of the set of one or more network slices.

6. The UE of claim 5, wherein a slice specific parameter of the at least one slice specific parameter comprises an offset of the common parameter.

7. The UE of claim 1, wherein the at least one neighbor cell comprises each of a plurality of neighbor cells that are either supportive of or unsupportive of the set of one or more network slices.

8. The UE of claim 1, wherein the processor is further configured to:
receive slice supporting capability information indicating respective network slices supported by each of a plurality of neighbor cells including the at least one neighbor cell.

9. A network entity, comprising:
a memory; and
a processor coupled to the memory, the processor being configured to:
receive slice information identifying at least one network slice configured for a user equipment (UE) and supported by a serving cell of the UE;
receive slice supporting capability information indicating respective network slices supported by each of a plurality of neighbor cells of the serving cell; and
identify at least one candidate target cell of the plurality of neighbor cells for a handover of the at least one network slice based on the slice information and the slice supporting capability information, the at least one candidate target cell supporting the at least one network slice.

10. The network entity of claim 9, wherein the processor is further configured to: provide a slice specific conditional handover configuration to the UE comprising the at least one candidate target cell.

11. The network entity of claim 10, wherein the slice specific conditional handover configuration further comprises a slice specific execution condition for executing a handover to a target cell of the at least one candidate target cell.

12. The network entity of claim 10, wherein the slice specific conditional handover configuration further comprises a respective slice specific conditional handover configuration for each of the at least one network slice and a respective priority of each of the respective slice specific conditional handover configuration.

13. The network entity of claim 9, wherein the processor is further configured to: receive a measurement report comprising slice specific assistance information, the slice specific assistance information comprising a respective measurement for at least one neighbor cell of the plurality of neighbor cells that supports the at least one network slice.

14. The network entity of claim 13, wherein the measurement report comprises a highest measurement associated with a best neighbor cell of the at least one neighbor cell.

15. The network entity of claim 14, wherein the processor is further configured to: transmit a measurement report configuration requesting the UE to report the highest measurement in the measurement report.

16. The network entity of claim 13, wherein the at least one network slice comprises a plurality of network slices and the measurement report further comprises a respective priority associated with each of the plurality of network slices, and wherein the processor is further configured to:
identify the at least one candidate target cell further based on the respective priority of each of the plurality of network slices.

17. The network entity of claim 9, wherein the processor is further configured to: transmit the slice supporting capability information to the UE.

18. The network entity of claim 9, wherein the at least one network slice comprises a plurality of network slices, each having a respective priority associated therewith, and wherein the processor is further configured to:
identify the at least one candidate target cell further based on the respective priority of each of the plurality of network slices.

19. The network entity of claim 18, wherein the processor is further configured to:
receive a message comprising the respective priority of each of the plurality of network slices.

20. A user equipment (UE), comprising:
a transceiver;
a memory; and
a processor coupled to the transceiver and the memory, the processor being configured to:
receive a slice specific conditional handover configuration from a network entity via the transceiver, the slice specific conditional handover configuration being associated with at least one network slice of the UE; and
perform a conditional handover evaluation for the at least one network slice based on the slice specific conditional handover configuration.

21-30. (canceled)
